(19) United States
(12) Patent Application Publication
(10) Pub. No.: US 2011/0289162 A1
(43) Pub. Date: Nov. 24, 2011

(54) METHOD AND SYSTEM FOR ADAPTIVE DELIVERY OF DIGITAL MESSAGES

(76) Inventors: Wesley J. Furlong, Sykesville, MD (US); Todd C. Miller, Baltimore, MD (US); George Schlossnagle, Woodbine, MD (US)

(21) Appl. No.: 13/079,449

(22) Filed: Apr. 4, 2011

Related U.S. Application Data
(60) Provisional application No. 61/320,619, filed on Apr. 2, 2010.

(51) Int. Cl. G06F 15/16

(52) U.S. Cl. 709/206

(57) ABSTRACT

A system and method for automatically adapting digital message traffic flow evaluates message delivery disposition, latency and performance metrics such that the system operates more optimally in terms of both overall throughput as well as with respect to system sending reputation. Reputation is in the context of maintaining message flow within limits that are acceptable for a given destination, such that the sender behavior avoids being flagged as abusive or otherwise undesirable.

### PRIORITY CLAIMS AND REFERENCE TO RELATED APPLICATIONS

This application claims priority to related and commonly owned U.S. provisional patent application No. 61/320,619, filed Apr. 2, 2010, the entire disclosure of which is incorporated herein by reference.

### BACKGROUND OF THE INVENTION

1. Field of the Invention

The present invention relates to methods and systems for controlling delivery of digital messages such as E-mails transmitted via networks of computer systems.

2. Discussion of the Prior Art

Transmission of information in the form of digital messages over computer communication networks such as e-mail, text messages is an essential component of modern lives, in both business and leisure. Many businesses derive income from services built “on top of” digital messaging. For example, almost all online purchases trigger a message to confirm that a monetary transaction has taken place. Schools are increasingly making use of alerting services that broadcast text messages to mobile devices. Businesses use E-mail and instant messaging as an essential part of day-to-day business communication, both internally and externally. Internet Service Providers (“ISPs”) enable email services for personal and business use. E-mail Service Providers (“ESPs”) enable other businesses to efficiently send their marketing and other types of communication without requiring a significant investment in sending infrastructure. “Aggregators” provide gateways to text messaging protocols and act as an endpoint for submitting Short Message Service (“SMS”) and Multimedia Message Service (“MMS”) messages to cell phone provider networks.

Many digital messaging systems that send digital messages over the Internet use protocols such as Simple Mail Transfer Protocol (“SMTP”), in the case of E-mail, and other protocols when the digital message is other than e-mail, to send digital messages from one server to another. The messages can then be retrieved with a client using services such as Post Office Protocol (“POP”) or Internet Message Access Protocol (“IMAP”). Other protocols for sending digital messages that are e-mails include, but are not limited to, POP3, X.400 International Telecommunication Union standard (X.400), and the Novell message handling service (“MHS”) as well as the Extended Simple Mail Transfer Protocol (“ESMTP”). Examples of prior art message delivery systems are illustrated in FIGS. 1A, 1B, 1C and 2.

SMTP transports digital messages among different hosts within the Transmission Control Protocol/Internet Protocol (“TCP/IP”). Under SMTP, a client SMTP process opens a TCP connection to a server SMTP process on a remote host and attempts to send mail across the connection. The server SMTP process listens for a TCP connection on a selected port and the client SMTP process initiates a connection on the selected port. When the TCP connection is successful, the two processes execute a simple request-response dialogue, defined by the SMTP protocol, during which the client process transmits the mail addresses of the originator and the recipient(s) for a message. When the server process accepts these mail addresses, the client process transmits the e-mail instant message. The e-mail message contains a message header and message text (“body”) formatted in accordance with RFC 822 STD 11, the Standard for the format of Internet Text Messages. Mail that arrives via SMTP is forwarded to a remote server or it is delivered to mailboxes on the local server. Similar protocols are used for other digital message formats (i.e, other than e-mail).

The SMTP protocol (see, e.g., RFC 821 or the recently updated standard RFC5321) supports both end-to-end (no intermediate message transfer agents “MTAs”) and store-and-forward mail delivery methods. The end-to-end method is used between organizations, and the store-and-forward method is chosen for operating within organizations that have TCP/IP and SMTP-based networks. A SMTP client will contact the destination host's SMTP server directly to deliver the mail. It will keep the mail item from being transmitted until it has been successfully copied to the recipient's SMTP.

This is different from the store-and-forward principle that is common in many other electronic mailing systems, where the mail item may pass through a number of intermediate hosts in the same network on its way to the destination and where successful transmission from the sender only indicates that the mail item has reached the first intermediate hop. The RFC 821 standard defines a client-server protocol. The client SMTP is the one which initiates the session (that is, the sending SMTP) and the server is the one that responds (the receiving SMTP) to the session request. Because the client SMTP frequently acts as a server for a user-mailing program, however, it is often simpler to refer to the client as the sender-SMTP and to the server as the receiver-SMTP. A SMTP-based process can transfer electronic mail to another process on the same network or to another network via a relay or gateway process accessible to both networks. An e-mail message may pass through a number of intermediate relay or gateway hosts on its path from a sender to a recipient.

An example of the components of an SMTP system is illustrated in FIG. 1A. Systems that send digital messages other than e-mail have similar components. Referring to FIG. 1A, users deal with a user agent (“UA”, e.g., 120 and 160). The user agents for Windows™ include Microsoft Outlook™. The exchange of e-mail using, for example TCP, is performed by a Message Transfer Agent (“MTA” e.g., 140 or 150). The user's local MTA maintains a mail queue so that it can schedule repeat delivery attempts in case a remote server is unable. Also the local MTA delivers mail to mailboxes, and the information can be downloaded by the UA (see FIG. 1A). The SMTP protocol defines a mechanism of communication between two MTAs across a single TCP connection. As a result of a user mail request, the sender-SMTP establishes a two-way connection with a receiver-SMTP. The receiver-SMTP can be either the ultimate destination or an intermediate one (known as a mail gateway). The sender-SMTP will generate commands, which are replied to by the receiver-SMTP (see FIG. 1C).

A typical e-mail delivery process is as follows. Delivery processes for digital messages other than e-mail follow similar scenarios. In the following scenario, a sending user at terminal 100 sends an e-mail message to a recipient user at an e-mail address: recipient@example.org. Recipient can review that e-mail message at terminal 170. Recipient's ISP uses mail transfer agent MTA 150.

Initially, the sending user composes the message and actuates or chooses “send” using mail user agent (MUA) 120. The sending user's e-mail message identifies one or more intended recipients (e.g., destination e-mail addresses), a subject heading, and a message body, and may specify one or more attachments.

Next, MUA 120 queries a DNS server (not shown) for the IP address of the local mail server running MTA 140. The DNS server translates the domain name into an IP address of the local mail server and User agent 120 opens an SMTP connection to the local mail server running MTA 140. The message is transmitted to the local mail server using the SMTP protocol. An MTA (also called a mail server, or a mail exchange server in the context of the Domain Name System) is a computer program or software agent that transfers electronic mail messages from one computer to another. The message is transmitted to MTA 150 from MTA 140 using the SMTP protocol over a TCP connection.

The recipient user at terminal 170 has user agent 160 download recipient's new messages, including the sending user's e-mail message. The recipient's MTA 150 is responsible for queuing up messages and arranging for their distribution. MTA 150 “listens” for incoming e-mail messages on the SMTP port, and when an e-mail message is detected, it handles the message according to configuration settings or policies chosen by the system administrator. Those policies can be defined in accordance with relevant standards such as Request for Comment documents (RFCs). Typically, the mail server or MTA must temporarily store incoming and outgoing messages in a queue, known as a the “mail queue.” Actual size of the mail queue is highly dependent on one's system resources and daily message volumes.

In some instances, referring to FIG. 1B, communication between a sending host (client) and a receiving host (server), could involve a process known as “relaying”. In addition to one MTA at the sender site and one at the receiving site, other MTAs, acting as client or server, can relay the electronic mail across the network. This scenario of communication between the sender and the receiver can be accomplished through the use of a digital message gateway, which is a relay MTA that can receive digital messages prepared by a protocol other than SMTP and transform it to the SMTP format before sending it. The digital message gateway can also receive digital messages in the SMTP format, change it to another format, and then send it to the MTA of the client that does not use the TCP/IP protocol suite. In various implementations, there is the capability to exchange mail between the TCP/IP SMTP mailing system and the locally used mailing systems. These applications are called digital message gateways or mail bridges. Sending digital messages (e.g., e-mail) through a digital message gateway may alter the end-to-end delivery specification, because SMTP will only guarantee delivery to the mail-gateway host, not to the real destination host, which is located beyond the TCP/IP network. When a digital message gateway is used, the SMTP end-to-end transmission is host-to-gateway, gateway-to-host or gateway-to-gateway; the behavior beyond the gateway is not defined by SMTP.

Existing digital message sending systems are sometimes unsatisfactory. Digital messages (e.g., e-mail) sent to a given domain (e.g., a particular ISP) or site may be blocked. However, typically, the blocking domain will either not specify why the digital message was blocked or will provide incomplete information as to why the message was blocked. In one example, the reason why a domain will block incoming digital messages is that a digital message quota, where the quota is based for example on a number of allowed digital messages per unit of time (e.g., per day, per week, per month) from the sending domain has been exceeded. However, the conventional sending digital messaging sending system (e.g., MTA 140 of FIG. 1A) does not learn that a quota has been exceeded from the message failure notices that are returned to the sending MTA by the blocking domain. So the digital message sending system continues to resend the blocked digital messages and send any new additional digital messages (e.g., e-mail, text messages, etc.) in its queue to the blocking domain even though there is no chance that the blocking domain will accept the resent digital messages or the new digital messages from the digital message sending system because the quota has been exceeded.

In another example, the receiving domain may be down because of equipment failure or scheduled maintenance. There are, therefore, many reasons why a digital message sending system may send digital messages to the receiving domain and meet with failure. But the digital message sending system will continue to resend the digital message and any new digital message in its queue to the receiving domain on some predetermined retry basis without intelligently backing off from its efforts to send out the digital message to the domain that is down.

It is reported that the majority of E-mail traffic (in excess of 80-90%, depending on the source of the statistics) is classified as “Spam” (unsolicited or otherwise unwanted messages). It is increasingly difficult for both senders and receivers to ensure that E-mail messages arrive successfully at the intended recipient's inbox. This is due in part to a pessimistic stance being adopted by the receivers; their inbound systems are burdened with the task of accurately classifying and processing messages that may have Spam, Virus or Phishing content and E-mail receivers are fighting a constant battle with the increasing volume of unwanted messages and trying to balance that with an increasing cost in infrastructure to deal with that load. This has resulted in systems programmed to implement a set of incoming E-mail processing policies that penalize bulk senders by throttling back reception rates or delaying inbound mail reception, making it difficult for their E-mail to reach the inbox on-time if ever. These receiver policies result in “Deliverability Issues” for the senders; not only is delivery slowed down, but it is often done in such a way that makes it difficult for the sending system to take appropriate action.

Many smaller E-mail sending sites resort to tricks at the firewall that result in traffic mysteriously stopping, rather than sending back a definitive response code. This tactic is aimed at illegitimate senders where it is effective at avoiding load, but is especially harmful to legitimate senders because it increases the resource utilization of the sending system by making the sending system try harder to deliver the messages. The slowdown in reception causes a bottleneck on the sending system that increases resource utilization and CPU load, and can in turn have an impact on the sending rates for mail intended for other destinations.

If a sender is seen to trigger enough of these receiver policies, the sender may have their sending IP address placed on a “blacklist” shared with other recipient domains. Blacklisting causes the triggering sender to have deliverability issues at other receiving sites too. The result of these conditions is that it is difficult for a legitimate bulk sender to achieve high throughput without establishing some kind of relationship, either directly or indirectly through a “deliverability expert”, with the administrators for the domains to which they intend to deliver their mail. Such a relationship will enable the sender to determine traffic shaping rules that are acceptable to the recipient and are typically dependent on the volume of messages being sent over an extended period of time and the historical and ongoing reputation of the sender (e.g., is this sender a known spammer, or does this sender otherwise have a high complaint rate from the ultimate recipients?). Other factors may apply; the inbound mail policies are not necessarily public and, by necessity, the policies change over time.

Having established appropriate traffic shaping rules for a given recipient domain, the sender's software can be configured to respect those rules. As the rules change, the software configuration will also need to be adjusted accordingly. This is an ongoing support burden for both the sender and the receiver of messages. Even with the correct shaping rules in place, it is possible for a sender to trip up and damage their reputation.

Many senders re-sell their services to others and act as Email Service Providers (ESPs). It is possible for an ESP customer to send a batch of e-mail that is widely regarded as spam; if enough of this content is sent through the ESP system it can result in blacklisting the system and impact the mail throughput for other customers of that ESP. A diligent administrator at an ESP should be able to monitor and take action in the aforementioned case, but would need to be very focused on that task to be effective.

While much of this document refers to E-mail, the same principles and problems apply to all digital messaging protocols and platforms; text messaging (SMS), multimedia messaging (MMS), instant messaging (XMPP and other proprietary protocols). Popular social media platforms, such as Twitter^{SM} and Facebook^{SM} also expose messaging interfaces for external applications to similar problems.

There is a need, therefore, for a convenient, flexible and effective method and system for adapting to changes and controlling delivery of digital messages such as E-mails transmitted via networks of computer systems.

### OBJECTS AND SUMMARY OF THE INVENTION

Accordingly, it is an object of the present invention to overcome the above mentioned difficulties by providing a convenient, flexible and effective method and system for adapting to changes and controlling delivery of digital messages such as E-mails transmitted via networks of computer systems.

In accordance with the present invention, the sender is provided with a method and system to adaptively maintain and supervise message traffic in a manner which helps to maintain a good reputation with receivers. The method and system of the present invention works by using a combination of:

(a) message delivery disposition information (e.g., was the delivery attempt successful, was it deferred or was it rejected outright? what reason was given?), and

(b) internal system performance metrics to make adjustments to outbound traffic shaping parameters (such as message delivery rate).

The method and system of the present invention can make the decision to suspend or even abandon delivery of messages for a given recipient system based on these factors.

The present invention is not limited to purely reactive processing; an important component is knowledge of acceptable traffic parameters and the interpretation of delivery responses for well-known recipient systems. These are handled in the present invention via an adaptively updatable rule set that can be delivered to the sending system in an automated fashion. The present invention may be configured to generate selected alerts in the form of a digital message (email, text message, SNMP trap and so forth, as supported by the sending system), or by executing a script, in the event that the system makes an adjustment of the configuration, based on the system configuration. For example, one Sender's administrator may only wish to be notified of suspensions or abandonment and not be concerned about increases in “message send” rate, whereas another Sender's administrator may be intensely interested in all such changes effected by the system.

Additionally, the method and system of the present invention allows administrative control in the form of setting additional specific limits that act as guard rails and in the form of an administrative override for traffic suspension or abandonment (i.e., termination of the E-mail sending activity to a given receiver).

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1A is a block diagram illustrating the traditional components included in a simple SMTP communications system, in accordance with the Prior Art.

FIG. 1B is a block diagram illustrating the components often included in a Relay MTA connected SMTP communications system, in accordance with the Prior Art.

FIG. 1C is a flow chart illustrating Traditional Message Delivery Workflow, and shows the steps that are taken by a sending system in delivering digital messages, in accordance with the Prior Art.

FIG. 2 is a flow chart illustrating Traditional Message Disposition Processing, and shows the steps that are taken to process both successful and failed digital message delivery attempts, in accordance with the Prior Art.

FIG. 3 is a flow chart illustrating Adaptive Delivery Workflow in accordance with the present invention, and should be contrasted with the process illustrated in FIG. 1C to illustrate changes in delivery workflow in the present invention.

FIG. 4 is a flow chart illustrating Typical Delivery Attempt Workflow, and illustrates and expands the “Attempt Delivery” box from FIG. 1C to demonstrate some of the factors that influence the delivery processing in a sending system.

FIG. 5 is a flow chart illustrating Adaptive Message Disposition Processing in accordance with the present invention, and should be contrasted with FIG. 2 to illustrate changes in delivery workflow in the present invention.

FIG. 6 is a block diagram illustrating the components included in a simple SMTP communications system, in accordance with the present invention.

FIG. 7 is a block diagram illustrating the components included in a Relay MTA connected SMTP communications system, in accordance with the present invention.

FIG. 8 is a flow chart illustrating reactive processing in the face of greylisting in accordance with the present invention, and shows the steps taken by a sending system when faced with a greylisting problem.

FIG. 9 is a flow chart illustrating reactive processing for a mail block in accordance with the present invention, and shows the steps taken when temporarily deferred because of complaints by the receiving user.

FIG. 10 is a flow chart illustrating reactive processing for a permanent mail block in accordance with the present invention, and demonstrates the operation of a blackhole.

FIG. 11 is a flow chart illustrating reactive processing to adjust batch size in accordance with the present invention, and demonstrates the steps taken when too many messages are sent in one session.

FIG. 12 is a flow chart illustrating reactive processing to adjust sending rate in accordance with the present invention, and demonstrates the steps taken when receiver has too many recipients including the sender during a receiver specified period of time.

FIG. 13 is a flow chart illustrating reactive processing to adjust sending concurrency in accordance with the present invention, and demonstrates the steps taken when the sender has established too many connections to the receiver.

FIG. 14 is a flow chart illustrating the steps taken to respond to a particular dynamic block response, in accordance with Prior Art.

FIG. 15 is a flow chart illustrating reactive processing to a particular dynamic block response in accordance with the present invention, and relates to the process illustrated in FIG. 14 to indicate changes in the delivery flow in the present invention.

FIG. 16 is a flow chart illustrating IP Warmup in accordance with the present invention, and demonstrates some of the responses by the adaptive module based on the age of the source IP address.

FIG. 17 is a flow chart illustrating reactive processing to a response indicating that warmup is required in accordance with the present inventions, and shows the steps that are taken when the mail server IP has exceeded the rate limit.

FIG. 18 is a flow chart illustrating statistics based on message disposition in accordance with the present invention, and shows the steps that are taken in gathering the statistics when delivery is attempted.

FIG. 19 is a flow chart illustrating statistics on Feed Back Loop in accordance with the present invention, and shows the steps taken in gathering the statistics when reported by the end-user.

FIG. 20 is a flow chart illustrating periodic aggregate disposition processing in accordance with the present invention, and demonstrates the behavior that results in a specific scenario.

### DETAILED DESCRIPTION

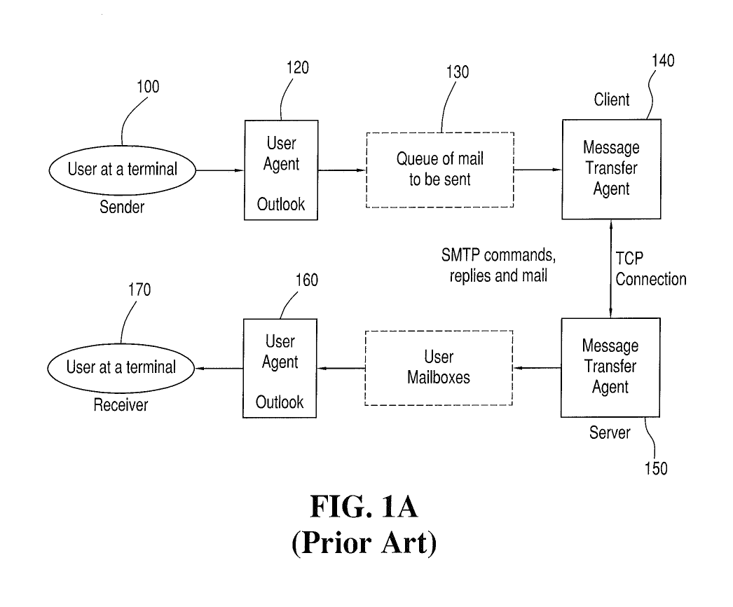

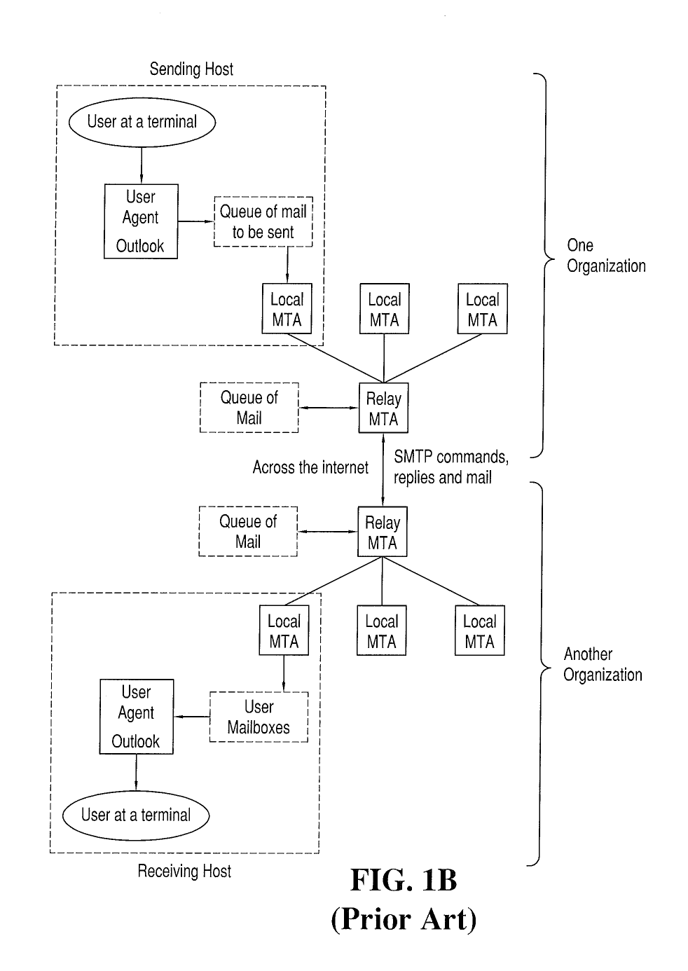

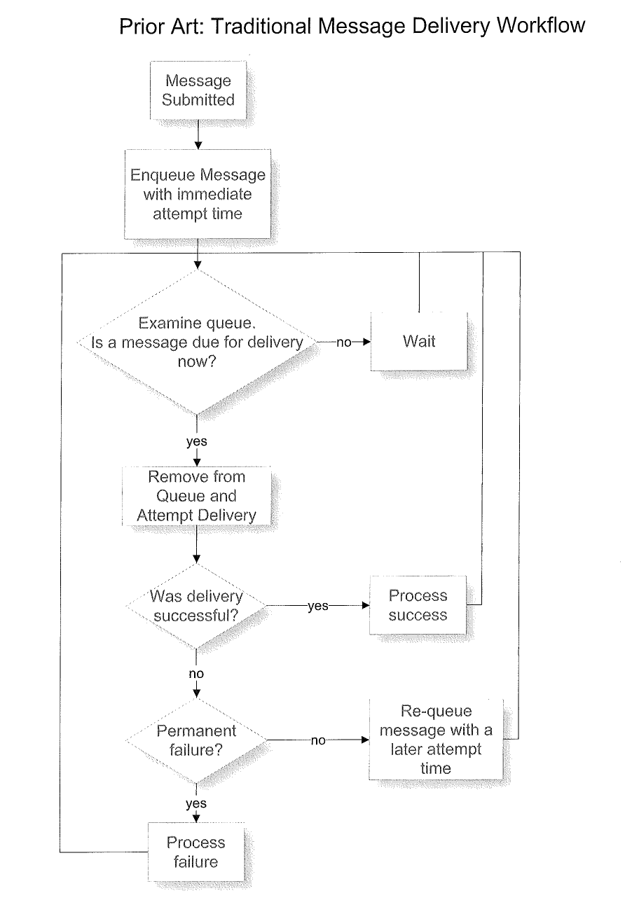

Turning now to FIGS. 1A-20, FIGS. 1A-2 illustrate the components and method steps employed in traditional E-mail transmission from a sender's terminal 100 to a recipient's terminal 170, as discussed above.

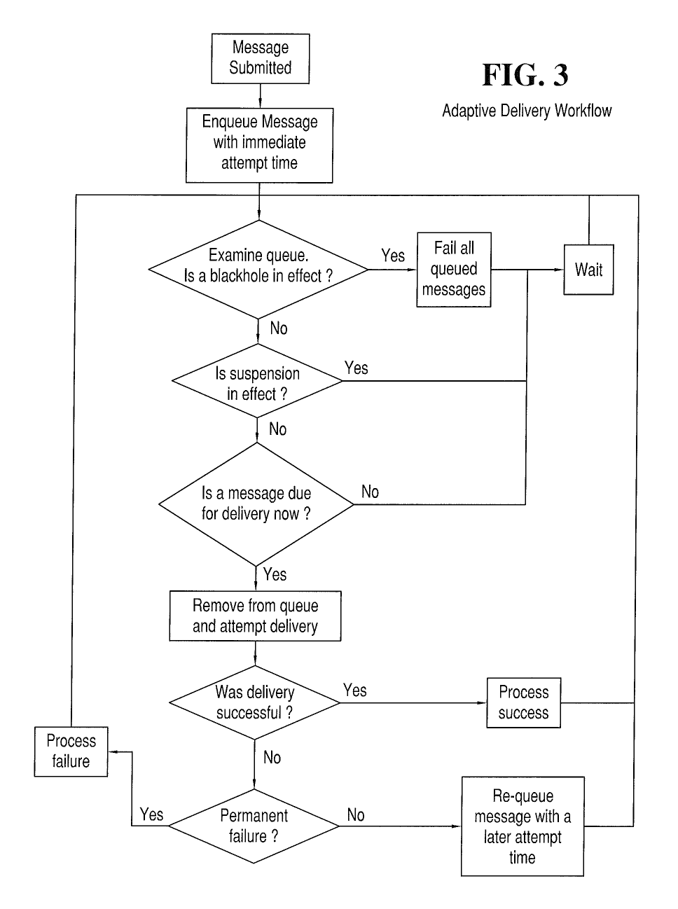

The system and method of the present invention (as illustrated in FIGS. 3-13 and 14-20) is readily implemented using traditional computing and data transmission equipment (e.g., using hardware similar to the components shown in FIGS. 1A and 1B), when programmed to perform the method steps described below. At the outset, it is helpful to define nomenclature or terminology.

### TERMINOLOGY

Throughout the remainder of this description, when the term “per-domain” is used, it indicates some preference or behavior that is scoped to a given recipient system. For instance, when referring to email, joe@example.com and bob@example.com are two distinct recipients that are serviced by the same email domain (i.e., example.com). It is typically the case that the receiving system for an email domain (and indeed, for other messaging protocols) enforces the same overall reception policies at the domain level rather than for individual recipients. When this text refers to a per-domain sending rate, it indicates a rate that applies equally to all recipients at a given domain for all messages.

Additionally, when this text uses the term “per-binding-domain” it further narrows the concept of “per-domain” to scope it to a particular binding, which may be a physical binding to a network interface or address or a logical binding used to segment traffic from the perspective of the sending system, but is otherwise not able to be discerned by the recipient system. The latter case is useful more for reporting or accounting purposes of the sending system than for specific deliverability; it is included in this description for completeness.

When this text refers to a per-binding-domain sending rate, it indicates a rate that applies equally to all recipients at a given domain for messages associated with a given binding. In terms of a concrete example, a sending system may be configured with multiple bindings that map to a number of network addresses assigned to the system. Messages queued to the system by “Customer A” are bound to one of those addresses; whereas messages queued to the system by “Customer B” are bound to a different address. Messages from “Customer A” may be subject to a different per-binding-domain sending rate than those from “Customer B” based on a combination of explicit system configuration and adjustments made by this present invention.

For the most part, the context of the rest of this text is “per-binding-domain” unless detailed otherwise.

The following description illustrates the method of the present invention in an exemplary context of e-mail message processing, as a means of furnishing an example, but the present invention is also applicable to all present and future digital messaging protocols, and the scope of the present invention should not be construed as being limited to these illustrative embodiments. Returning to the nomenclature:

Blackhole refers to arranging for message traffic to be failed without attempting delivery. This is treated as a permanent failure and logged as such.

Disposition refers to the result of a message delivery attempt. Messaging protocols allow for an explicit response code that indicates the degree of success, and will also provide a supplemental field to convey additional context. For example, a system may indicate a transient rejection and specify “message permanently deferred” as part of the response. In this case, the sending system should instead reclassify the response as a permanent failure.

D.S.N. or DSN refers to a Delivery Status Notification, and M.D.N. or MDN refers to a Message Disposition Notification. These are auxiliary messages generated by a relaying system in order to convey information about the disposition or status of a message delivery attempt back to the originator of the message. In normal operation these are sent to indicate that a permanent failure was encountered, but it is possible in some system configurations to notify the originator of events such as transient failure and successful delivery. Furthermore, some systems allow the sender to request additional status or disposition notification at the time of submission of a message.

Permanent Failure or Permanent Rejection refers to a message disposition that indicates that the message will never be successfully delivered. Most likely causes are either due to an invalid recipient or other receiver policy or configuration decisions that prevent the message from being accepted. The two terms are from the perspective of the sender and recipient, respectively.

Transient Failure or Transient Rejection refers to a message disposition that indicates that the message was not successfully delivered, but that trying again at some later time could result in a successful delivery. Most likely causes are due to a transient resource limitation (perhaps the system load is too high, or disk space utilization is too high), or due to greylisting. The two terms are from the perspective of the sender and recipient, respectively.

Greylisting refers to the technique of a receiving MTA issuing a transient rejection in cases where it is unsure whether it wants to accept the message. Classic greylisting is effectively a throttle scoped to a particular sender, recipient and sending IP triplet (see, e.g.: http://projects.puremagic.com/greylisting/whitepaper.html), but some sites employ a statistical mechanism whereby a given send attempt has a chance of triggering the greylisting response.

Turning now to FIG. 3, FIG. 3 illustrates the Adaptive Delivery Workflow and should be contrasted with the process illustrated in FIG. 1C to illustrate changes in delivery workflow in the present invention. In the context of Applicant's invention, when Applicant has decided that it would be beneficial to do so, Applicant may set the status for a queue to be “blackhole”. The steps taken for this are:

1. Record the blackhole status and expiration time in the adaptive delivery data store
2. Send a notification to the administrator that a blackhole has been enacted
3. For each message currently in the queue that has been set to blackhole:

Record a failure due to blackhole to the appropriate logs

Remove the message from the spool

4. During reception of new messages into the system, the system will inspect the blackhole status for the queue that will be used. If the queue status is set to blackhole, and the blackhole period has not expired, instead of accepting delivery of the message, the System will reject the message and return an error message indicating that a blackhole is in effect. This allows Applicant to avoid paying 10 costs for journaling the message to spool. Applicant also logs the rejection message to the appropriate logs. These steps mean that Applicant will not attempt delivery to the destination until the blackhole status has expired.

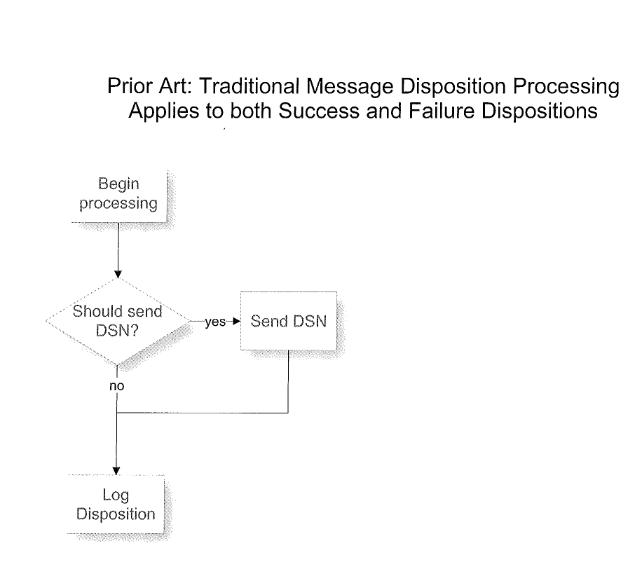

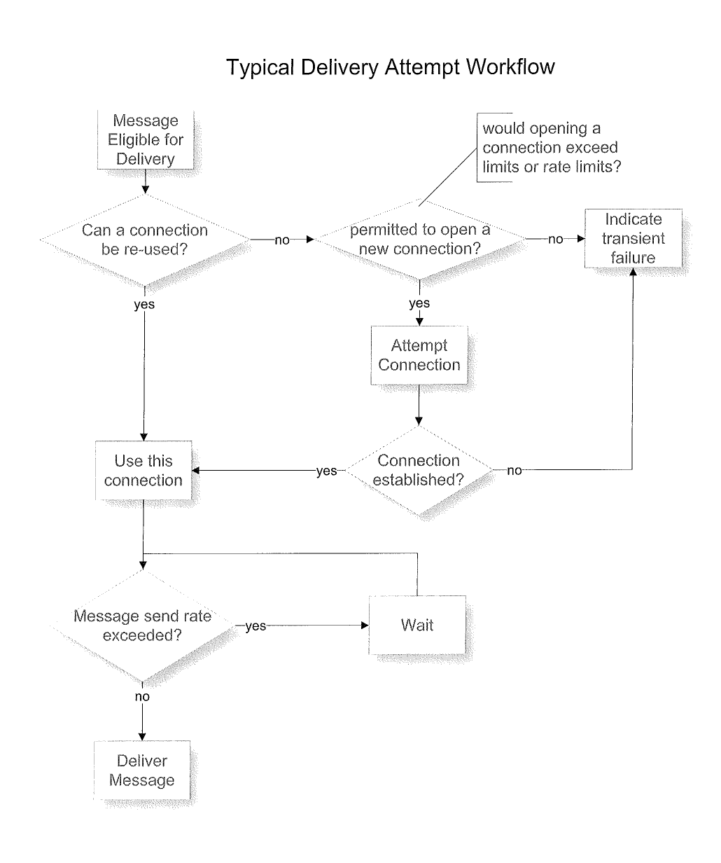

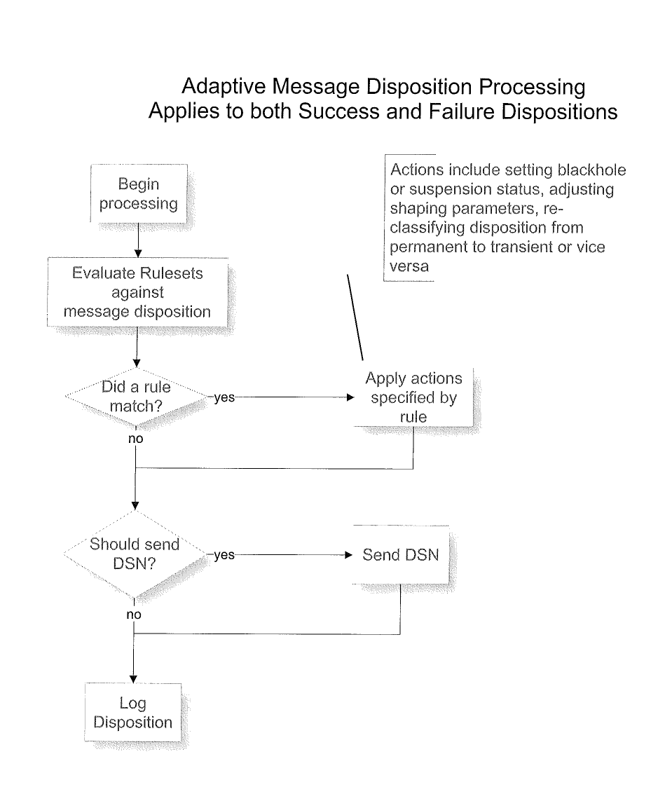

FIG. 4, is a flow chart illustrating Typical Delivery Attempt Workflow and includes newly developed subject matter which supplements and improves upon the subject matter identified in the “Attempt Delivery” box from FIG. 1C to demonstrate some of the factors that influence the delivery processing in the present invention's sending system. The “Wait” block indicates that the system is idle pending some other externally or internally triggered action. FIG. 5 is a flow chart illustrating Adaptive Message Disposition Processing and should be contrasted with FIG. 2 to illustrate changes in delivery workflow in the present invention. The figure applies selected adaptive actions specified by the matching rule; wherein said adaptive actions may include setting a blackhole status, setting a suspension status, adjusting shaping parameters, throttling down sending rate to a selected limit, reclassifying disposition from permanent to transient or reclassifying disposition from transient to permanent.

### DETAILED DESCRIPTION OF AN EXEMPLARY EMBODIMENT

The method and system of the present invention work by modifying, either directly or via a hooking or extension mechanism, a system including message sending software such that the system can monitor deliverability on a per-binding-domain basis; this is done by maintaining statistics and monitoring the responses returned from the recipient as part of the appropriate messaging protocol dialogue. The system of the present invention also hooks the traffic shaping aspects of the sending software such that it can specify the values that will be used for those shaping parameters. There are several paths by which adjustments are made to the sending system:

### Time-Based:

Once a minute, each “binding-domain” (sending-IP-address and recipient-domain combination) is assessed. If the proportion of bounced mail is above a configurable threshold, then it is diagnosed as having a deliverability issue and is suspended. The act of suspending the binding-domain causes an alert to be triggered. An alert may be an SNMP trap and/or an email notification, or some other kind of message dispatch as supported by the system (such as a text message sent via SMS/MMS, a pager notification sent via SNPP, an Instant Message via XMPP and so forth).

### Reactive:

By hooking into sending software, the method and system of the present invention can assess the final disposition of delivery attempts as they occur (see FIG. 5). The invention maintains a rule-set of known or accepted best practices for a number of recipient domains. Each time a delivery attempt concludes unsuccessfully, the rule-set for the recipient domain is assessed one rule at a time, comparing the disposition with the rule criteria. Actions specified by rule include setting a blackhole or suspension status, adjusting shaping parameters, reclassifying disposition from permanent to transient or vice versa.

If the disposition matches, the rule is checked to see if it should trigger, based on the acceptable frequency of the occurrence coded into the rule. For instance, if a batch of 100 messages results in a particular response 100 times in the course of 1 minute it may be desirable to have the action associated with the rule trigger only once instead of 100 times.

If a rule is deemed to have “matched” and so is triggered, one or more of the following actions can be taken:

Suspend the sending-IP-recipient-domain combination for a period of time, preventing it from being attempted for delivery until the suspension is lifted. An alert is triggered for a suspension, as described above.

Cause mail associated with the sending-IP-recipient-domain combination to be discarded without further delivery attempts for a period of time (Blackhole). An alert is triggered when this rule is enacted, as described above.

Increase or decrease overall traffic shaping rules by one step for the sending-IP-recipient-domain combination. These are used described in the just-in-time section below.

Adjust the retry interval for the sending-IP-recipient-domain combination to handle a greylisting response from the recipient site. Greylisting is a technique used by receivers when they are unsure about a sender; it results in mail being delayed until a later time. The invention adjusts the retry interval such that retries are made more or less aggressively depending on the content of the greylisting response. For instance, if the response indicates that greylisting is being applied for the next 30 minutes, the retry interval will be adjusted to match that, as a more aggressive schedule may result in bad reputation, and a less aggressive schedule will result in longer delays than are necessary.

Adjust the age of the sending-IP address. The age is used as a parameter in the just-in-time section below.

Adjust a specific traffic shaping parameter by a specified amount (positive or negative). Possible parameters are listed below.

Re-interpret a transient rejection response as a permanent rejection response

Re-interpret a permanent rejection response as a transient rejection response

### Just in Time/Proactive

The invention hooks into the email sending system such that it can override configuration values as they are evaluated. For instance, when determining the number of connections that should be established to a recipient domain for a given sending-IP-address, the invention is invoked and is able to make a traffic shaping adjustment at that time, if it necessary.

The system and method of the present invention use this vector to assess whether it should make a proactive adjustment to the shaping parameters. This adjustment can be made based on the information collected for the binding, and can be either a positive or a negative adjustment. In an exemplary embodiment, Applicants have implemented a very simple algorithm that increases the shaping parameter by one positive increment if we have not made a negative adjustment in the past hour (configurable).

Proactive adjustments are throttled such that the system will not make more than one adjustment for a sending-IP-recipient-domain combination in a given minute interval (configurable). This prevents the system from rapidly increasing its parameters to the point where it would cause a deliverability issue; by slowly stepping in the changes, the system can react to the disposition returned from the receiving domain and correct the action before it becomes a serious problem.

Running just-in-time avoids expensive configuration adjustments that would be required if the logic behind the adjustments was run as a periodic assessment; there are a large number of traffic shaping parameters and with customers using several thousand IP addresses to send to 50,000 domains, the processing required for assessing the status of the system would become computationally prohibitive.

The effective configuration value can be expressed in a parametric form, such that the value can be computed based on a rule-defined function. We use this form to express rules such as “new IP addresses should limit their send rate to X per hour until they have sent Y messages, at which point they can increase to Z messages per hour”. These rules are usually derived from accepted best practices for well-known receivers.

### User Configuration or Interaction

The invention was built such that a system administrator can override the actions of the invention to by configuring guide rails (upper and lower bounds) for each configuration option that the invention adjusts, as well as being able to selectively enable or disable the adaptive delivery capabilities on a per sending-IP-recipient-domain combination.

The invention provides interactive commands via a command console to allow the administrator to introspect or clear the state of the traffic shaping parameters. The console also provides the ability to list and override suspensions or blackholes triggered by rulesets.

A daily report email is generated that summarizes the deliverability and parameters for the administrator.

### Parameters

The invention specifically makes adjustments to the following parameters, although the technique can be generally applied to any of the systems parameters that affect load and resource management. The values may be scoped globally or on a per-sending-IP-per-recipient-domain basis, or some combination thereof, such that overrides put in place can be specified once for a given recipient-domain (or even globally) without having to be specified explicitly for each possible sending IP address (as they may number into in the thousands). A description of the parameters as they apply to Applicant's system is supplied to aid the reader in understanding the nature of the parameters; the invention is not specifically limited to operating with parameters that have precisely the same meaning.

Max_Deliveries_Per_Connection—the number of deliveries attempted on a given TCP connection before closing the connection

Max_Outbound_Connections—the number of concurrent connections permitted for a given recipient domain

Outbound_Throttle_Messages—the maximum rate at which messages may be sent

Max_Recipients_Per_Connection—the maximum number of recipients permitted to be sent on a given TCP connection before closing the connection. Similar to Max_Deliveries_Per_Connection, but takes into account the fact that email messages may be addressed to multiple recipients in a batch email.

Max_Recipients_Per_Batch—the maximum number of recipients permitted to be sent as part of a batch email send for a given message. Messages that have more than this number of recipients are broken up into smaller batches.

Idle_Timeout—the time period to keep a connection open to given recipient domain address after the sending queue has been exhausted. The connection may be re-used within this time period to reduce the overhead of re-establishing the connection if more mail arrives for that destination.

EHLO_Timeout—the time period that the sending system will wait for a response from the recipient system when waiting for the SMTP “EHLO” response.

MailFrom_Timeout—the time period that the sending system will wait for a response from the recipient system when waiting for the SMTP “MAIL FROM” response.

RCPTTO_Timeout—the time period that the sending system will wait for a response from the recipient system when waiting for the SMTP “RCPT TO” response.

BODY_Timeout—the time period that the sending system will wait for a response from the recipient system when waiting for the SMTP “DATA” response.

RSET_Timeout—the time period that the sending system will wait for a response from the recipient system when waiting for the SMTP “RSET” response.

Retry_Interval—the base time period which should elapse before re-attempting delivery of a message that was transiently rejected by the recipient. In Applicants system, this time period is applied exponentially with each additional retry until the message expires from the system.

Max_Retries—the maximum number of delivery attempts before determining that a message will never be accepted and thus be expired from the system.

Max_Resident_Active_Queue—the maximum number of messages to be committed to RAM for a given recipient domain queue. If the volume of messages in the queue exceeds this number, the excess messages are put into a lower resource consumption mode that requires a disk access before they can be sent.

Thread Pool size—Applicant's system uses a number of pools of threads to carry out certain tasks. The optimal number of threads for a given system depends on the workload, which in turn can vary over time.

Outbound_Throttle_Connections—the maximum rate at which new connections may be established

Inbound_Throttle—the maximum rate at which new messages are allowed into the system

Max_Resident_Messages—the maximum number of messages that can be committed to RAM for the system overall, as opposed to the Max_Resident_Active_Queue which is the per recipient domain value.

Max_Retry_Interval—caps the effective retry interval value when calculating the interval based on the number of attempts and the Retry_Interval

Metrics/Consumed information

The following metrics/information are fed into the invention and can influence its actions in Applicant's current implementation:
Message disposition for permanent and transient failure responses
Permanent failure rate for the binding-domain expressed as a percentage of delivery attempts over the last hour
The age of a binding (IP address), expressed as time since the address was first used.

The following metrics/information can be consumed by the invention but, at the time of writing, are not yet utilized in the current implementation:
Average delivery time in seconds over the last hour
Average length of time taken to dispatch a job to a particular thread pool over the last hour.

### Implementation:

The invention is implemented in two parts; a module written in the “C” language that hooks into the email system internals and a module written in the “Lua” language that implements the majority of the algorithms. The latter part is implemented in “Lua” so that the rule-sets update mechanism can be implemented without the need to deliver compiled object files that are system specific. This implementation choice is not a fundamental requirement of the invention, but a convenience for Applicant's software delivery mechanism in that it reduces overheads for development and deployment of revised rules.

### Initialization

The adaptive module initializes by attaching hooks to monitor message disposition and override the effective value of configuration parameters as listed above in 6.5. It also arranges to run a periodic task known as the “bounce sweep” at an interval specified by the Bounce_Sweep_Interval parameter; this defaults to hourly. The adaptive module maintains its state in a data storage medium, such that a process or system restart does not cause it to lose its settings.

### Bounce Sweep

The purpose of this task is to periodically (based on the Bounce_Sweep_Interval parameter) iterate each binding-domain (distinct source IP address and recipient domain), and if adaptive tuning is enabled for that binding-domain (as controlled by the Adaptive_Enabled parameter), and if the number of delivery attempts exceeds the value specified by the Adaptive_Attempt_Threshold parameter (default 100), examine the sending failure rate expressed as the number of failures divided by the number of attempts.

If the failure rate exceeds the value specified by the Adaptive_Rejection_Rate_Suspension_Percentage parameter (default 10%), and if no other adaptive adjustments have been applied within the period specified by the Adaptive_Adjustment_Interval parameter (default 60 seconds), then the binding-domain is suspended as detailed in 6.7.3, for a duration specified by the Adaptive_Default_Suspension parameter (default 4 hours).

A future implementation of the invention will apply similar rules and processing around the transient failure rate.

### Fine Grained Assessment Based on the Classification of Delivery Failures

The ultimate cause of a failed delivery attempt can be one of many varied reasons, some more serious than others, from the perspective of maintaining a good sending reputation (for example, a high volume of invalid recipient address responses can lead to the sender being blocked).

In applicant's preferred embodiment, a standard bounce classification facility analyzes the protocol level responses and classifies them into one of a number of possible broad reasons, such as “mailbox is full”, “message too large” and so forth. In Applicant's embodiment, the classification system is supplied with some system defined classification codes, and a facility that allows a local administrator to define and expand rules that will classify new and varied responses to match the system defined codes. Furthermore, the same facility allows the local administrator to define new classifications. Each classification is identified by a classification code, which happens to be a numeric code in Applicant's implementation, but could also be some other identifier.

Applicant's preferred embodiment of the Adaptive Delivery facility is to record the incidence of each classification code as protocol level (such as SMTP) responses are received. These classification codes are tracked historically such that the volume of any particular classification code encountered for a given binding-domain over the time period specified by the Bounce_Sweep_Interval parameter are known to the system.

The Bounce Sweep task, in addition to the basic processing described in 6.7.2 above, can be configured to act upon the rates of bounce classifications passing defined thresholds by defining rules that have the following attributes:

A list of the bounce classification codes

A low threshold, expressed as a percentage

A high threshold, expressed as a percentage

An action to be triggered when the low threshold is crossed

An action to be triggered when the high threshold is crossed

The Bounce Sweep task will assess the rules that are defined for a given binding-domain, as controlled by the Adaptive_Enabled parameter, using the following logic:

define a volume counter and initialize its value to 0

define an attempts counter and set it to the number of delivery attempts made by the current binding-domain over the prior Bounce_Sweep_Interval time period

compare the value of the attempts counter with the Adaptive_Attempt_Threshold parameter (default 100). If the attempts counter is less than the attempt threshold, stop processing the current rule and continue processing with subsequent rules.

For each bounce classification code listed with the rule, retrieve the volume of failures classified with that code and add that value to the volume counter that was initialized in the first step
compute a rate percentage by dividing the volume counter by the attempts counter
if the rate percentage is greater than or equal to the value of the high threshold parameter, then apply the action specified by the high threshold action parameter and stop processing the current rule, continue processing with subsequent rules.

if the rate percentage is greater than or equal to the value of the low threshold parameter, then apply the action specified by the low threshold action parameter and stop processing the current rule, continue processing with subsequent rules.

The action referred to in the description of the high/low threshold actions above can be any one of the actions listed in section 6.7.6.

The system is pre-configured with a rule with the following parameters:

Classification codes: “hard bounce”, “mailbox full”, “message too big”

low threshold 3%

low action (“throttle” “down”)

high threshold 10%

high action (“suspend” “4 hours”)

This has the effect of slowing down the sending rate once the combined total of failures classified as “hard bounce”, “mailbox full” or “message too big” exceeds 3%, and suspending the mail flow when this rate reaches 10%.

There may be multiple rules, and those rules can be expressed on a binding-domain basis by the local administrator.

### Abuse Feedback Loop Processing

The (prior art) open standard for complaint feedback loop processing is a feedback loop (FBL), sometimes called a complaint feedback loop, and provides an inter-organizational form of feedback by which an Internet service provider (ISP) forwards the complaints originating from their users to the sender's organizations. ISPs can receive users' complaints by placing report spam buttons on their webmail pages, or in their email client, or via help desks. The message sender's organization, often an email service provider, has to come to an agreement with each ISP from which they want to collect users' complaints. As an alternative, abuse complaints may be directly sent to addresses where such feedback might be received. Target abuse mailboxes can be assumed to be in the form defined by RFC 2142 (abuse@example.com), or determined by querying either the regional Internet registry's whois databases—which may have query result limits—or other databases created specifically for this purpose.

The receiving sites that implement FBL processing have very stringent requirements on the volume of complaints that are issued against a given sender; it is not uncommon for a sender to be blocked if less than 1% of their messages result in complaints. As such, it is important to react to FBL information as quickly as possible.

In accordance with the present invention, a preferred embodiment has a facility that recognizes FBL report message payloads (as described by RFC 5965) and records their incidence in a similar fashion to that described in section 6.7.2.1 above, except that it does so over a separate, longer, time period known as the FBL_Sweep_Period. The default for this parameter is 24 hours.

The Bounce Sweep task, in addition to processing the rules in section 6.7.2.1 above, processes a very similar of rules that are specific to FBL. The rules have similar attributes:

A list of the applicable FBL report types (eg: abuse, fraud, virus, other)

A low threshold, expressed as a percentage

A high threshold, expressed as a percentage

An action to be triggered when the low threshold is crossed

An action to be triggered when the high threshold is crossed

The logic for evaluating and acting upon these rules is similar to that described in section 6.7.2.1 above, except that instead of using the Bounce_Sweep_Interval as the time period used for assessing the volume, the FBL_Sweep_Period is used. It is important to note that this logic is still evaluated every Bounce_Sweep_Interval, such that the preferred embodiment in its default configuration assesses the FBL rules every hour, but acts upon rate data collected over the preceding 24 hours.

Applicant's preferred embodiment provides a default setting for this rule:

All FBL report types

low threshold 0.2%

low action (“throttle” “down”)

high threshold 0.5%

high action (“suspend”, “4 hours”)

This has the effect of slowing down mail, perhaps stepping down the throttle multiple times, while a significant volume of FBL reports are discovered, with the intention of ultimately suspending delivery prior to the receiver enacting a mail block.

### Suspend Domain

The purpose of this task is to cease delivery attempts for a particular binding-domain (distinct source IP address and recipient domain) for specified time duration.

This task will trigger a notification with the message “suspending for <duration>” as detailed in 6.7.4.

It will then record in the adaptive module state that the binding-domain is subject to suspension for the requested duration. It will not alter or extend the state of a suspension that may already be in place.

Finally, it will clear the adaptive tunings it has put in place as part of Configuration Modification.

### Notify

The purpose of this task is to notify the administrator that an event took place. When invoked, the triggering binding (sending IP), domain (recipient domain), rule, triggering disposition information and descriptive text are passed in as parameters. To avoid repeatedly sending the same notification in a short time span, the notify routine throttles the notification such that for a given set of triggering criteria (based on the parameters passed in above), no more than 1 notification is generated in each interval specified by the Adaptive_Notification_Interval parameter (default 1 hour).

When a notification is generated, the implementation will generate an email message payload (which may be routed out of this system via some other protocol, such as SMPP, as dependent on the system configuration) addressed to the recipients specified by the Adaptive_Alert_Email_Destination parameter (must be configured by the system administrator) and sourced from the address specified by the Adaptive_Alert_Email_Sender (default is the NULL sender address, which cannot be replied to).

The notification message payload includes the text:

This is an alert generated by the Adaptive Delivery Component.

The alert pertains to:

Domain: <DOMAIN>
Binding: <BINDING>
Host: <HOSTNAME-OF-THE-MACHINE-GENERATING-
THE-ALERT>

It also includes the triggering information in the message payload, as well as the descriptive text. For example, in the case of a domain suspension, the descriptive text will be “suspended for <DURATION>”.
The subject of the notification message is formatted as:

```
  ALERT: <BINDING>/<DOMAIN> on
  <HOSTNAME-OF-THE-MACHINE-
GENERATING-THE-ALERT>.
```

Alternatively, notifications may be to be sent in the form of an SNMP trap.

### Configuration Modification

In Applicant's implementation, the Adaptive Delivery module performs the bulk of the parameter adjustments by hooking into the configuration system, such that it can modify the effective values of the system parameters as specified in 6.5. We chose to do this rather than change the actual configured value for two reasons. The first is that application of a changed configuration can have some heavyweight processes associated with it to validate overall configuration consistency and potentially invalidate cached information. In short, regular adaptive tunings can potentially negatively impact performance if they are implemented in this way in Applicant's system. The second reason for implementing as a reader-hook is that it allows the value to be computed parametrically at the time it is needed. This allows powerful rules to be expressed.

This section of the text details the steps that are taken to determine the effective value of a parameter at the time it is needed.

For a given configuration parameter, the Adaptive Delivery hook is invoked and passed the configured value specified by the user in the configuration file, the name of the parameter being interrogated and the binding-domain information (the source IP address and recipient domain). It is important to note that the system supports both binding-domain specific configuration and binding specific configuration. When an option is being queried at the binding level, no domain will be passed to the interrogation function.

If the parameter is Suspend_Delivery or Blackhole, and the configuration system indicates that the parameter is disabled (indicating that traffic should flow as usual), the Adaptive Delivery data store is consulted to determine if a Suspension or Blackhole (respectively) is in effect. The result of this consultation is used as the effective value for these parameters, and further processing for them stop here. The rest of this section details what happens to the other parameters.

If the parameter is not Suspend_Delivery and not Blackhole, then the adaptive “guide rail” values are determined by obtaining the value of the parameter named “Adaptive_<PARAMETERNAME>”. For example, if the parameter currently being interrogated is “Max_Outbound_Connections”, then the value of the “Adaptive_Max_Outbound_Connections” parameter is examined to determine acceptable lower and upper bounds for the range of tuning. There is no default value for these guide rail values; if they are not explicitly configured then there is deemed to be no user override for the parameter tuning.

If there is no user-specified guide value, the rule-sets are consulted according to the following logic:
1. If the rule-set defines an alias for the specified domain, re-interpret the domain as though it was specified as the alias and repeat, until we have arrived at a canonical ruleset, or a domain with no specified rules. This allows for a single set of rules to be defined for a site that has many distinct top-level-domains (TLDs). An example of this is Yahoo!; they have many different top-level domains to establish their presence in many different territories. If no domain was provided to this interrogation function, treat the domain as though it specified the global wildcard rule-set named “*”.
2. If a rule-set is defined for the domain specified by the result of step 1, proceed to step 4.
3. This step transforms a name of the form subdomain.example.com to a pattern string of the form “*.example.com” (a wildcard rule-set). If a rule-set is defined for this modified name, proceed to step 4. It is important to note that this step does not perform an actual wildcard match, it is checking to determine if there is a wildcard rule-set defined. If no wildcard rule-set is defined, this step repetitively strips off the node name from the left hand side until it either finds a defined wildcard rule-set or arrives at the global wildcard rule-set named “*”. If the domain to be interrogated is “subdomain.example.com” then the following set of rule-set names, in this specified order, will be searched and the search will stop at the first defined rule-set: “subdomain.example.com”, “*.example.com”, “*.com”, “*”.
4. Given a rule-set from step 2 or 3 above, the rule-set is examined to determine if it defines a configuration guide for the configuration value being interrogated. If it does not, and we arrived here as part of a search from Step 3, the search is continued until we arrive at a rule-set that does define a guide or until there are no more rule-sets to examine.

At this point, we have either a guide value specified by the system administrator from the configuration file, or the most specific guide value for the binding-domain of interest as specified in the rule-sets, or no guide value.

If no guide value is found, then it is deemed that no adaptive tuning is allowed and the configured value for the parameter it returned to the system. Otherwise, the following steps are taken:
1. The age of the binding (sending IP) is determined. If the adaptive delivery module has never observed the binding before, the current time is recorded as the “birth date” for the binding and will be used as the basis of subsequent binding age determination and processing moves to Step 5.
2. Otherwise (the binding is already known to the adaptive module), the recorded value for the parameter being interrogated, the last_change time for that parameter, and the number of messages sent to the domain from the binding are looked up from the adaptive delivery data store.
3. Determines if the value for the parameter being interrogated should be adjusted. If the binding-domain is suspended, the value will not be adjusted. If it is not suspended, and the last_change time is more than the value of the Adaptive_Positive_Adjustment_Interval parameter (default 1 hour) and if no other adjustments have been applied for this binding-domain within the time interval specified by the Adaptive_Adjustment_Interval parameter (60 seconds), then the value is subject to adjustment.
4. If the value is subject to adjustment, the current implementation simply increases the value by adding 1 to it.
   a. Future implementations may use larger values, perhaps scaled according to the range of the guide values, or even negative values, based on related metrics, such as observed message throughput changes over time, average time for delivery changes over time and outgoing bandwidth utilization from the source IP to the recipient domain changes over time.
5. At this point, we have arrived at a value for the parameter that started at the number configured in the configuration file, and that may have been subject to adjustments per the rules above. The next step is to apply the guide value that was determined based on the recipient domain.
   a. If the guide value is a pair of values, it is interpreted as lower and upper bounds for the value. If the binding is new (we arrived here from step 1), we treat the effective value as that specified by the lower bound in the guide. Otherwise, the possibly-adjusted value is clipped such it is not less than the lower bound and not greater than the upper-bound specified by the guide.
   b. If the guide value is a numeric value, it is used as a single fixed value that cannot vary; it overrides the user-specified configuration (if any) for the parameter being interrogated.
   c. If the guide value is a function type, it is a parametric guide and is invoked, passing the possibly-adjusted value, the age of the binding (expressed as time since the birth-date recorded in Step 1), and the number of messages sent to the recipient domain from that binding. The return value of the parametric guide function is used as the new adjusted parameter value.
6. If the value for the parameter was adjusted as part of the above processing, it is stored in the adaptive delivery data store, so that it is recorded and available in the event of a process or system restart
7. The possibly-adjusted value for the parameter is returned to the interrogator.

Applicant's implementation employs a cache such that all of the processing described in this section is triggered at most once in every 60 seconds (this can be adjusted via the Adaptive_Cache_TTL parameter).

### Disposition Processing

In reference to FIG. 5, the following text describes in detail the actions taken by the adaptive system during message disposition processing. These actions are triggered at the point where the system has attempted delivery of a message and the destination system has returned an error code and a supplemental description. In the context of SMTP, this will be of the form “250 OK” for a successful delivery, “452 user over quota” for a transient failure (in this case indicating that the recipient mailbox is full) or “550 no such user” for a permanent failure (in this case indicating that the recipient is not known at that address).

For reference, the SMTP protocol is described in RFC 5321 (see, e.g., http://www.rfc-editor.org/rfc/rfc5321.txt) and defines the numeric codes mentioned above in section “4.2.1 Reply Code Severities and Theory”. The SMTP reply codes are augmented by a widely adopted standard for enhanced status codes described in RFC 1893 (see, e.g., http://www.rfc-editor.org/rfc/rfc1893.txt) that includes a machine readable auxiliary code in the supplemental description. For example, the “user over quota” response called out above could be returned instead as “452 4.2.2 user over quota” to positively indicate to the sender that the mailbox was indeed full, as distinct from a generic system storage exceeded status implied by the 452 reply code.

This description focuses on SMTP as a means of illustrating the invention, but the method of the present invention is not limited to SMTP; other message delivery protocols have analogous concepts and map to this scheme. It should also be noted that Applicant's implementation currently maps these other protocol responses to equivalent SMTP responses.

The following steps are taken when assessing the disposition of messages; the context of this evaluation includes the message itself as well as the routing information for that message. That routing information includes the destination or recipient domain for the message, as well as the binding (Source IP) that the message is attached to. This section refers to these items as domain and binding, respectively.

In Applicant's implementation, there are certain internally triggered events that will cause these rules to be triggered, but where adaptive processing is not required. The first example of this is at process start-up; if there are messages in the spool that are past their expiration time, the system will treat them as permanent failures and trigger the adaptive processing. Applicant's implementation specifically shortcuts the adaptive processing in this case and instead takes the usual permanent failure processing path through the system.

If the parameter Adaptive_Enabled is set to false for the binding-domain pair from the routing information, the adaptive processing is skipped and regular disposition processing continues.

Next, a rule-set for the domain is determined by applying similar logic to that described in 6.7.5:
1. If the rule-set defines an alias for the domain, the domain is re-interpreted as the target of that alias, recursively until we are left with a domain that does not have an alias defined for it
2. If the rule-set defines disposition rules for the domain, we have found the rule-set for that domain and processing of those rules continues as described below this set of numbered bullet points.
3. If no disposition rules are defined for the domain, the domain is re-interpreted according to the following sequence, such that if a wildcard or higher-level hierarchy domain has rules defined, those rules will be used. If the domain is subdomain.example.com, it is interpreted as the following sequence of domains, one after the other, until a matching rule-set is located: “*.example.com”, “*.com”, “*”, or when the domain name is “*” and no rule-set is located

If there is no disposition rule-set defined for the domain, then no further adaptive processing is performed, and regular disposition processing continues. Otherwise, the disposition rule-set is processed by iterating over the defined rules, in the order they were defined.

Each rule in the rule-set can have the following properties:
Code—Perl Compatible Regular Expression pattern that is compared against the disposition of the message delivery attempt. If the pattern matches, then this rule is deemed to have triggered.
Trigger—the triggering threshold that must be met for the corresponding defined actions to trigger. If set to 1, the actions trigger on the first occurrence of the match. If set to “10/1”, the actions will trigger only if there have been more than 10 occurrences in the past second. “10/30” indicates that the actions will trigger only if there have been more than 10 occurrences in the past 30 seconds, and so on.
Phase—the protocol phase in which the code is expected to manifest. This property allows the rule-set to define different actions for a given response depending on when the response is issued. If the phase property is not set, the code in this rule is eligible for matching in any phase. An example of phase is “connect” to indicate a condition at connect time, or “data” to indicate a condition triggered after the message payload has been sent to the destination.
Action—a reference to a set of pre-defined actions that should be taken when this rule is deemed to have matched. Each action can specify a single parameter (which may itself by a rich data structure), and multiple actions may be listed against a particular rule. The following actions are defined in the current implementation; the names are listed inline below, but reference the sections that follow.
   Transcode
   Purge
   Suspend
   Blackhole
   Throttle
   Warmup
   Greylisted
   Reduce Connections
   Reduce Deliveries
Message—a descriptive reason that will be included in a notification that might be issued as part of processing the actions in this rule.

### Transcode Action

Cause the regular disposition processing to treat the message as though the delivery attempt resulted in a different outcome. For instance, some sites will return a response such as “451 mail permanently deferred”, which is a transient response. This results in the messages being retried by the sender until they expire. This action accepts the new status code as its argument.

A transcode rule allows the response to be re-interpreted as a permanent failure instead, resulting in a reduction in load on the sending system and a reduction in bandwidth usage to the recipient site. An example transcode rule definition is shown below:

{

code = “\hat{ }421 4\\.7\\.1 \\[TS03\\] All messages from

(?<IPADDRESS>\\d+\\.\\d+\\.\\d+\\.\\d+) will be permanently deferred”,

trigger = “1”,
action = {“transcode”, “554”, “blackhole”, “4 hours”},
message = “Remediation with Yahoo required”,
phase = “connect”,

},

This rule causes the “421” to be replaced with “554”, and a blackhole to be established. A notification will be triggered with the descriptive text “Remediation with Yahoo required”. This action is triggered immediately on detection of the “ . . . permanently deferred” response message when it occurs at connection time.

### Purge Action

The purge action causes the messages in the queue for the binding-domain (source IP and recipient domain for the message being examined) to be purged.

This action accepts a failure reason as its argument. Each message in the applicable queue is treated as though it failed due to the failure reason argument passed to this action.

### Suspend Action

This action triggers the suspension activity as described in 6.7.3.

The action accepts a time duration as its argument; this is used to specify how long the binding-domain should be suspended. An example suspension rule is shown below:

{

code = “\hat{ }421 4\\.7\\.0 \\[TS02\\] Messages from

(?<IPADDRESS>\\d+\\.\\d+\\.\\d+\\.\\d+) temporarily deferred due to user
complaints - 4\\.16\\.56”,

trigger = “5/1”,
action = {“suspend”, “4 hours”},
phase = “connect”,

},

This example will trigger a suspension if the “temporarily deferred” pattern specified by code is matched 5 times in the space of 1 second; when it does, message flow is suspended for a period of 4 hours.

### Blackhole Action

The blackhole action enables blackhole mode for the specified binding-domain. Reference FIG. 4; when a blackhole is enabled, the regular delivery workflow is altered such that instead of delivering mail, the mail is instead treated as failed without making a delivery attempt.

Similar to the suspension processing (See 6.7.3), this action will trigger a notification with the message “blackholing for <duration>” as detailed in 6.7.4. It will then record in the adaptive module state that the binding-domain is subject to blackhole for the requested duration. It will not alter or extend the state of a blackhole that may already be in place.

In the method of the present invention, when it would be beneficial to do so, the system may set the status for the adaptive module used with a queue to “blackhole”. The steps taken for this are:

1. Record the blackhole status and expiration time in the adaptive delivery data store
2. Send a notification to the administrator that a blackhole has been enacted
3. For each message currently in the queue that has been set to blackhole:

Record a failure due to blackhole to the appropriate logs

Remove the message from the spool, and

4. during reception of new messages into the system, the system will inspect the blackhole status for the queue that will be used. If the queue status is set to blackhole, and the blackhole period has not expired, instead of accepting delivery of the message, the system will return an error message indicating that a blackhole is in effect. This allows the system's users to avoid paying 10 costs for journaling the message to spool. The system also logs the rejection message to the appropriate logs. These steps mean that the system will not attempt delivery to the destination until the blackhole status has expired.

### Throttle Action

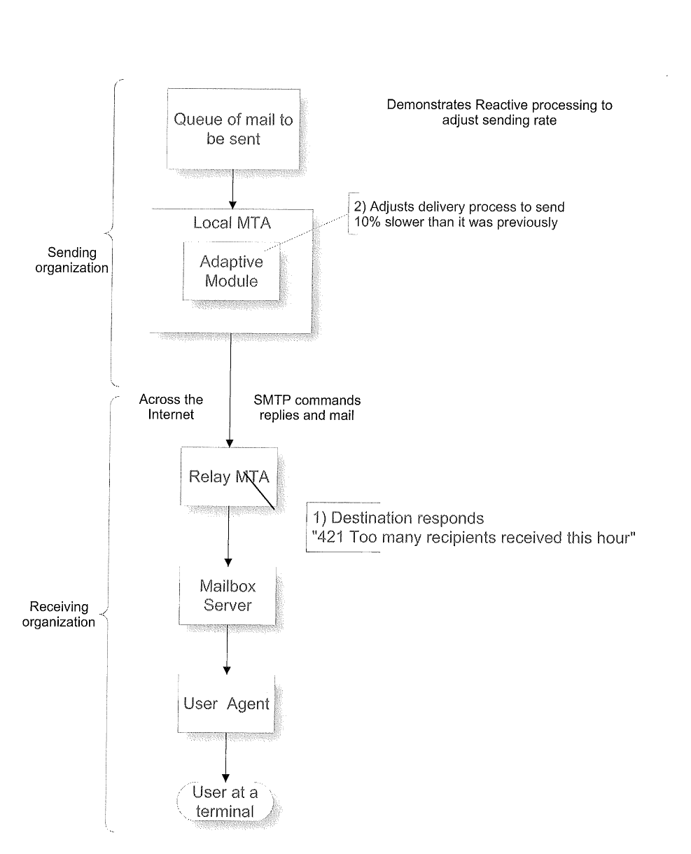

As illustrated in FIG. 12, the throttle action makes an adjustment to the traffic shaping parameters such that the sending rate is adjusted in a direction specified the parameter passed to the action.

Applicant's implementation currently only supports throttling “down”, but it is envisioned that there may be some circumstances where throttling “up” is desired. The throttle action takes the following steps:

Triggers a notification that the throttling parameters are being adjusted, per 6.7.4, with the informational text “adjusting throttle <DIRECTION>”.
When throttling “down”, the current (possibly-adjusted via 6.7.5) value of the Outbound_Throttle_Messages parameter (default is not specified; a given rule-set may establish a best practice default, and this may be adjust edvia 6.7.5) will be reduced by 10%. If Outbound_Throttle_Messages is explicitly configured to be unlimited, the throttle action has no effect.

### Warmup

The warmup action causes the age (in seconds) of the binding (source IP) to be set to the value specified by the action parameter. The concept of IP Warmup is that many well-known receiving sites have established policies around the volume of messages that they want to see from a given sender, and that these policies are often time based, resulting in a relatively low allowed throughput in the first two weeks (for example) of the IP being established, and ramping up over time after that point.

The adaptive module implements these policies via parametric configuration guides, as described in 6.7.5. One of the parameters used in these guides is the age of the binding.

An example warmup rule is shown below:

{

code = “421 PR\\(dt1\\) *The mail server IP connecting to

Windows Live Hotmail server has exceeded the rate limit allowed on this
connection. If you are not an e-mail/network admin please contact your
E-mail/Internet Service Provider for help\\.
For e-mail delivery information, please go to
http://postmaster\\.live\\.com”,

trigger = “1”,
action = {“warmup”, “1”},
phase = “connect”,

},

The above rule cases the age of the binding to be reset to 1 second when a connection attempt results in the text above being returned.

### Greylisted Action

The greylisted action is intended to be applied in situations where greylisting is detected. The intention is to tune the retry time such that the next delivery attempt will be made at the “right” time without unnecessary delivery attempts before we know that the receiver site is willing to accept the message.

In the current implementation, the greylist action expects a time duration as its parameter. This specifies the revised retry interval. A future implementation might instead extract the duration from the disposition itself.

When the greylist action is invoked, the current (possibly adjusted, per 6.7.5) value for the Retry_Interval parameter is determined. If the parameter value is less than the time duration parameter passed to this greylist action, the Retry_Interval parameter will be adjusted upwards to match the greylisting duration.

Additionally, the (possibly adjusted, per 6.7.5) value for the Max_Retry_Interval parameter is determined. If the parameter value is less than a reasonable number derived from the greylist duration (in the current implementation, we use 4 times the greylist duration), then the Max_Retry_Interval parameter is adjusted upwards to match the reasonable number (4 times the greylist duration).

An example greylisting rule is shown below:

{

code = “(?i)grey ?list”;
trigger = “1”,
action = {“greylisted”, “15 minutes”},
phase = “rcptto”,

},

This is a rather generic match that triggers the greylisted action whenever the disposition text contains the string “grey list”, “Greylist”, “Grey list” or “grey list”.

### Reduce Connections Action

The reduce connections action expects as its parameter a delta that will be applied to the Max_Outbound_Connections parameter.

When invoked, the (possibly adjusted, per 6.7.5) value for the Max_Outbound_Connections parameter is determined, and the delta value is subtracted from it. If the resultant value is less than one, then it is clamped to have a lower limit of 1. This adjusted value is then used in the future when the system interrogates the value of the Max_Outbound_Connections parameter, as described in section 6.7.5, above.

### Reduce Deliveries Action

The reduce deliveries action expects as its parameter a delta that will be applied to the Max_Deliveries_Per_Connection parameter.

When invoked, the (possibly adjusted, per section 6.7.5, above) value for the Max_Deliveries_Per_Connection parameter is determined, and the delta value is subtracted from it. If the resultant value is less than one, then it is clamped to have a lower limit of 1. This adjusted value is then used in the future when the system interrogates the value of the Max_Deliveries_Per_Connection parameter, as described in section 6.7.5, above.

### System Diagrams

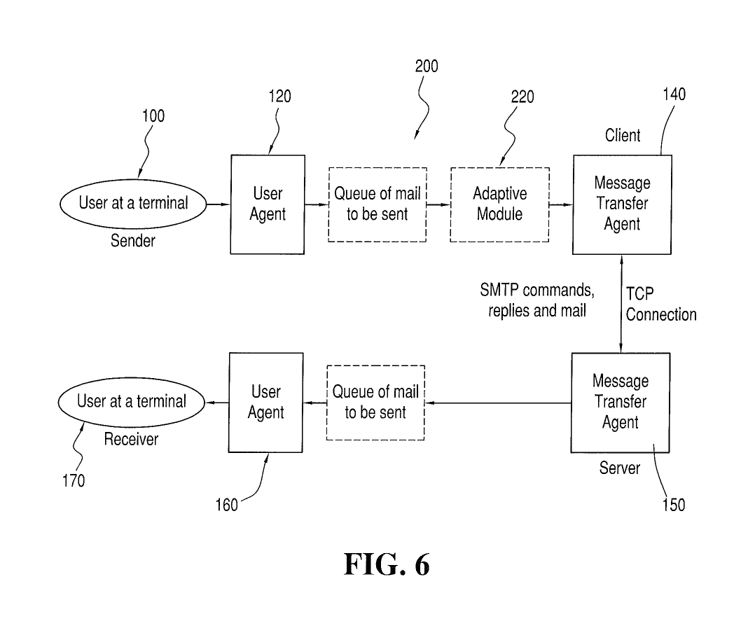

FIG. 6 is a system block diagram illustrating an implementation of the system of the present invention 200. The sender user sends a digital message from a sender terminal 100 intended for a receiving user. The message is sent through a user agent 120 which places the message into a queue of mail to be sent. The adaptive module of the present invention 220 is accessed to analyze the message based upon the configurations set by the system administrator for the binding-domain pair from the routing information. The message is then transferred to the client MTA 140 which transfers the message to the server MTA 150. The server MTA 150 places the message into a queue for delivery to the receiver's user agent 160. User agent 160 receives the message and makes it available for the receiver user at a receiver terminal 170.

Referring now to FIG. 6, user 100 and user agent 120 may be an individual person sitting at his or her computer using Microsoft Outlook, but “user” and “user agent” should not be limited to that example. A message injector is an automated system for automatically generating one or many commercial or non-commercial e-mails or digital messages. Messages automatically generated by a message injector could be automatically generated as a batch of merged message content with a plurality of selected addresses or in response to a selected event such as a message recipient's purchase. Thus, 100 may be a user configuring the batch parameters of the message injector, where examples of batch parameters include message content, overall list of recipients, and 120 can be an automated user agent which transmits a configured set of messages in response to the user's parameters.

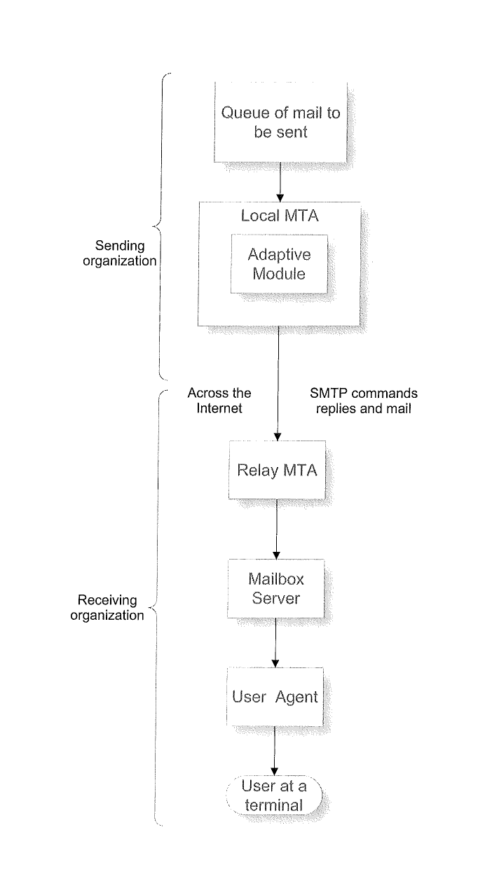

FIG. 7 is a system diagram illustrating an implementation of the present invention that involves relaying. Similar to the system 200 of FIG. 6, the sender user sends a digital message which is sent through a user agent. The user agent places the message into a queue of mail to be sent and it is analyzed by the adaptive module of the present invention. The message is then transferred to the local MTA, which instead of passing it directly to the receiving host's local MTA, it is passed to a Relay MTA. The Relay MTA places the message into a queue of mail before relaying the message across the internet between at least one other Relay MTA. The Relay MTA transfers the message to the receiving host's local MTA. The local MTA places the message into a queue for deliver to the receiver's user agent. The user agent receives the message and makes it available for the receiver user at a terminal.

The prior art message systems (e.g., as illustrated in FIGS. 1A, 1B and 1C) deal with the transfer of messages from one system to another by meeting the minimum requirements of the various specifications. That is, those systems are designed to receive the transmission of the messages, correctly storing them to the local disk (also known as spooling), and then working through the backlog of messages stored to the spool and delivering them on to the next hop.

This approach tends to be controlled, in most Message Transfer Agent (MTA) software, by a handful of parameters that affect the number of concurrent connections and overall message sending rate. These parameters are typically configured explicitly by a local administrator in response to the demands of their mail flow and, in the case of larger scale senders, based on the feedback from the recipients of that email. In the modern age of communication, the majority of email recipients share the same service providers (e.g., AOL^{SM}, Hotmail^{SM}, Gmail^{SM}, Yahoo^{SM} and so on), which means that the operators of those services are looking to find ways to manage the inflow of mail to reduce load on their systems and to reduce the incidence of Spam complaints.

As noted above, one of these techniques is known as “Greylisting”. One of the capabilities of the SMTP is the concept of a Transient Failure (a numeric code in the range 400-499) which indicates to the sender that they should requeue the message and try again later. Transient Failures are intended to reflect issues such as the system load on the receiving system being above some locally defined limit, or that the local system has exceeded a configured disk quota limit.

Greylisting takes advantage of the transient failure to reflect local policy choices rather than local resource issues. The prime example is that the receiver decides that they don't know enough about the reputation of the sender to make a decision about whether they want to receive the message; they are not on a blacklist (a list of known undesirable senders) and nor are they on a whitelist (a list of known good senders) but they are suspicious of the reputation. In this grey scenario, the receiver can opt to issue a transient failure, causing the sender to requeue the message and try again later, rather than the receiver taking a chance of relaying unwanted content through to the recipient.

Greylisting works well for receivers because it uses less of the high contention resources (the disk and CPU) and reduces the risk of relaying bad content. Some spam senders use special software, known in the industry as Ratware, that is either poorly engineered or deliberately engineered not to follow the precise details of the SMTP specification. One feature of ratware for the serious spam software is that it will not requeue messages if it encounters a transient failure response; it will simply move on to the next address in its list of addresses. Greylisting can effectively block a larger amount of this type of ratware generated spam.

Even if the messages that are greylisted are retried later on, there is still benefit to greylisting from the receiving side; in the time since the message was originally seen by the receiver, there may now be an updated antivirus or antispam ruleset that can classify the message as being unwanted content.

The above are the benefits of Greylisting for the receiver; they hint at the challenges they impose on legitimate senders, and we'll go into those now.

Greylisted messages are retained in the spool and queueing mechanisms of the sender until the messages are retried later on. A subsequent retry does not guarantee that the message will successfully leave the system; it may still be subject to greylisting on the receiving side. This causes problems for senders; because the sender has no information on how long it will be before the receiver will accept the message, there may be several attempts to deliver. Each delivery attempt results in IO and CPU costs to bring the message in from the spool and network costs to transmit the message. This is wasteful because, in this case, it is unnecessary.

At the opposite end of this is that the sender may opt to wait longer than is necessary to wait before attempting delivery, just based on the way that the majority of MTA software handles a retry schedule (it is common practice to exponentially back-off using a base period of about 15-20 minutes, meaning that after the first attempt the sender will wait 15-20 minutes before the next attempt; if that one is also transiently failed, then it will double the interval before the third attempt, and double it again for the fourth attempt and so on).

Applicant's Adaptive Delivery invention solves these greylisting problems by recognizing a greylisting type of response and intelligently revising the delivery schedule for messages on the same queue as that message.

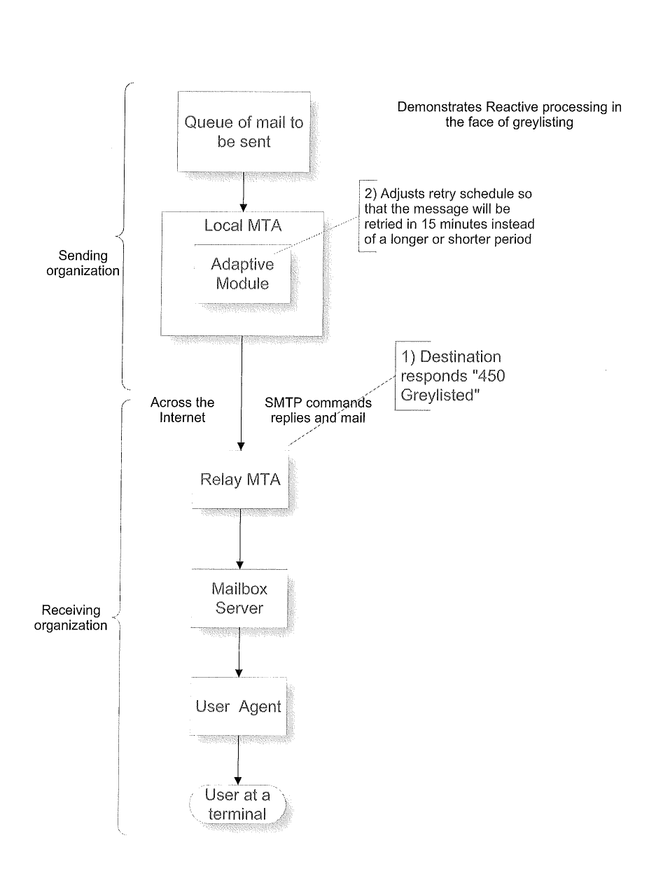

For instance, as illustrated in FIG. 8 (illustrating reactive processing in the face of greylisting), if a given message were being sent from a system using the method of the present invention to some other MTA, and that MTA responded with:

450 Greylisted

Applicant's solution would recognize this response via the following rule definition (and allow the local administrator to configure similar rules):

{

code = “(?i)grey ?list”;
trigger = “1”,
action = {“greylisted”, “15 minutes”},
phase = “each_rcpt”,

},

In this rule, the “code” line defines a Perl Compatible Regular Expression (PCRE) that matches the following substrings in the protocol response, case insensitively: “greylist” or “grey list”. If a match is found, the “trigger” line defines a triggering threshold, in this case it specifies that the action will trigger immediately. The “action” line specifies which system defined action (or actions) should be carried out when this rule is triggered. In this case, it triggers the “greylisted” rule with a parameter of “15 minutes”. The “phase” line scopes the rule to a particular phase of the SMTP protocol dialog; in this case, it is referring to the RCPT TO portion, which expresses each of a list of recipients.

The “greylisted” action used by the rule in this case has the effect of revising the delivery schedule for the queue of mail associated with the message, adjusting two important aspects of the retry schedule. As mentioned above, most MTAs use an exponential backoff to manage the retry schedule; Applicant's solution does this too, with the base period being controlled by a parameter Applicant calls “retry_interval”. Applicant also has another parameter that Applicant calls “max_retry_interval” which sets an upper bound on the retry interval For instance, if retry_interval=15 mins, then the retry schedule would be 15, 30, 60, 120, 240 and so on. By setting max_retry_interval=60, the retry schedule would be 15, 30, 60, 60, 60.

The greylisted action has the effect of intelligently adjusting both of these parameters based on the time period parameter passed in via the rule:

action={“greylisted”, “15 minutes”}

Applicant's invention will look at the retry_interval parameter; if it is less than 15 minutes, Applicant's invention will raise it to 15 minutes. This type of adjustment is justified because retrying too soon will simply waste CPU and IO resources. Applicant's invention will look at the max_retry_interval parameter; if it is less than four times the action parameter (in this case, 4 time 15=60 minutes), Applicant's invention will raise it to 60 minutes. The rational is similar to the above; having it too small is wasteful, but setting it too large may cause the system to wait too long before sending the message and may cause the sender to be greylisted again, causing an even longer delay.

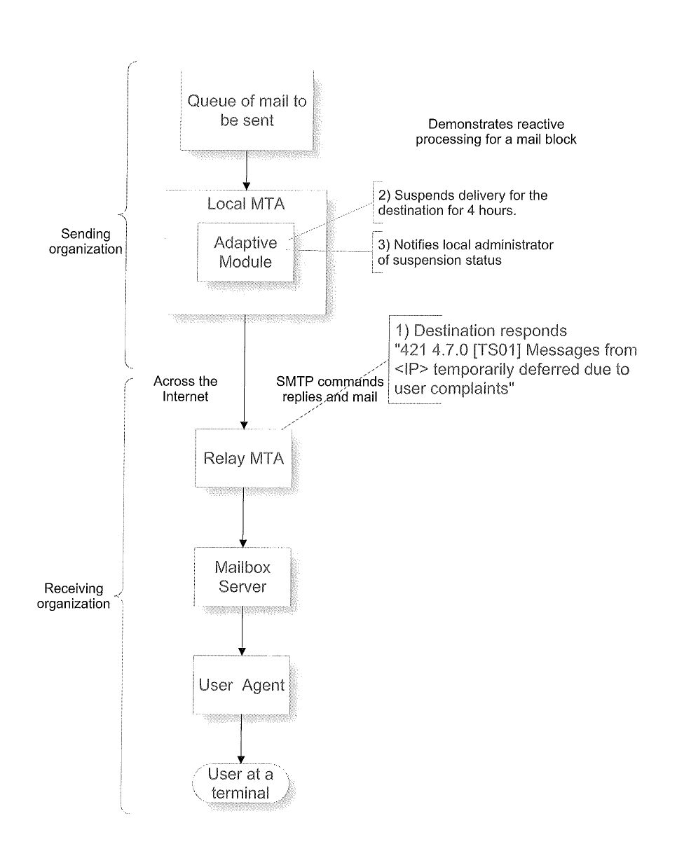

Another facet of Applicant's invention is to dynamically react to responses that indicate that the sender reputation is in jeopardy. Picture the following scenario; an email campaign is sent that has a poor choice of graphics or wording and causes a number of the recipients at the same recipient domain to flag the message as spam. The operator of the domain may automatically enact a temporary block targeted at the sender to prevent more of their users from reporting spam, as illustrated in FIG. 9. This type of block may result in subsequent delivery attempts receiving the following transient failure response:

421 4.7.0 [TS01] Messages from 10.0.0.1 temporarily deferred due to user complaints—4.16.55.1

Most MTAs will treat this just like any other transient failure and requeue the message per the usual retry schedule. In this case, the recipient domain publish their policy in this regard to be that the sender should not send any more messages for the next 4 hours. (in the preferred embodiment, at present). If the sender is using the typical retry schedule mentioned above, then they will be wasting resources by making those attempts, and may even be aggravating the situation with their reputation, as some receivers may decide that the repeated attempts are still too much and may escalate the block to be more permanent or wider reaching (perhaps blacklisting on a shared blacklist).

Applicant's invention avoids these cases with the use of rules (that can be modified or overridden by the local administrator) that can recognize this type of behavior. An example of one of these rules is found below:

{

code = “\hat{ }421 4\\.7\\.0 \\[TS01\\] Messages from

(?<IPADDRESS>\\d+\\.\\d+\\.\\d+\\.\\d+) temporarily deferred due to user
complaints - 4\\.16\\.55\\.1”,

trigger = “1”,
action = {“suspend”, “4 hours”},
phase = “connect”,

},

The “code” line is a PCRE that matches the type of response in the example above. In this case, the “phase” is “connect”, meaning that the rule is only assessed when connecting and not in subsequent phases of the SMTP protocol dialog (this reduces the amount of effort required to fully process the entire set of rules in use by the system). The critical part of this rule definition is that the “action” is set to “suspend” with a parameter of “4 hours”.

In Applicant's solution, the “suspend” action causes the queue associated with the message to have its delivery schedule suspended for the period specified; in this case, 4 hours. This means that the system will not waste any resources making attempts to deliver messages that will not make it out to the destination, and avoid potentially damaging the sending reputation any further.

When a suspension is enacted, Applicant's system will send an alert to the local administrator (or a list of users) to notify them of that fact, and perhaps give a suggestion of what steps should be taken (in this case none, but a later rule will illustrate this).

The suspensions that are currently in effect can be assessed by the local administrator and overridden if need-be (for instance, if the administrator remediated directly with the recipient and cleared the block). Another similar response might be the following:

421 4.7.1 [TS03] All messages from 10.0.0.1 will be permanently deferred

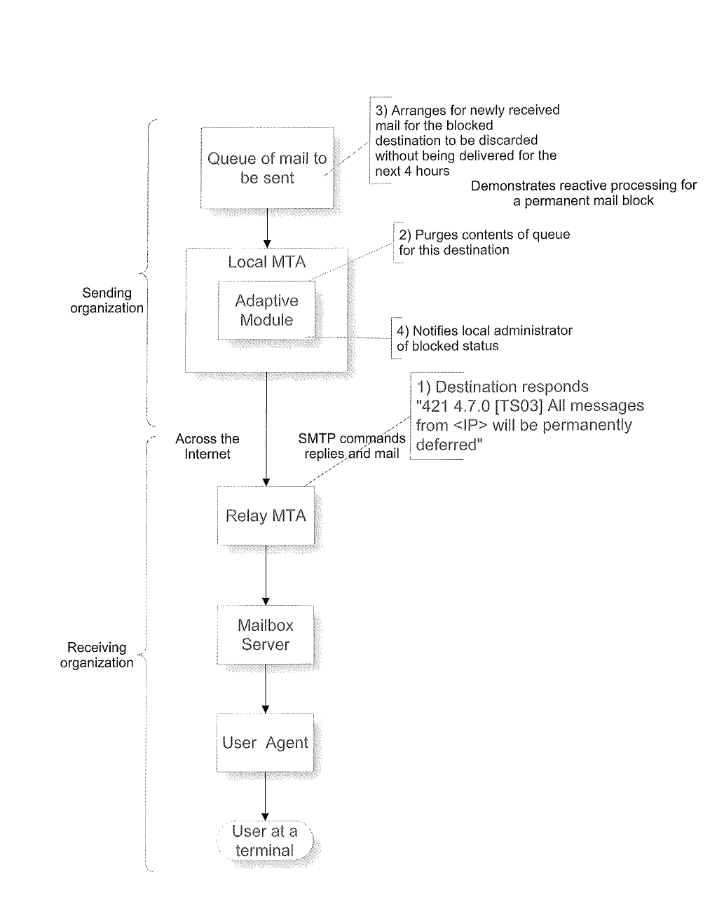

In this case, as illustrated in FIG. 10, the recipient has decided that they never want to receive any mail from the sender, most likely due to a persistent or recurring level of complaints about the sender, and no amount of retries will allow the mail to be accepted by the system unless some remediation takes place with the operator of the recipient domain.

This has similar ramifications to the scenario above; the sending system will continue to waste resources making attempts that will never succeed. Applicant's solution avoids the resource wastage by using the following rule:

{

code = “\hat{ }421 4\\.7\\.1 \\[TS03\\] All messages from

(?<IPADDRESS>\\d+\\.\\d+\\.\\d+\\.\\d+) will be permanently deferred”,

trigger = “1”,
action = {“suspend”, “4 hours”},
message = “Remediation with Operator Name required”,
phase = “connect”,

},

This is very similar to the preceding example, except that the “code” matches the SMTP response in this scenario, and that is demonstrates the “message” line, which is used to provide a suggestion to the local administrator that s/he has some action to take.

Another possibility allowed by Applicant's solution is to take that response to heart and to purge all mail queued to that recipient from that mail queue, and arrange for any subsequently received messages destined for that queue to be purged without making a delivery attempt. Applicant call this a “blackhole” because the mail is lost in the blackhole. Applicant might phrase the blackhole rule as follows:

{

code = “\hat{ }421 4\\.7\\.1 \\[TS03\\] All messages from

(?<IPADDRESS>\\d+\\.\\d+\\.\\d+\\.\\d+) will be permanently deferred”,

trigger = “1”,
action = {“blackhole”, “4 hours”},
message = “Remediation with Operator Name required”,
phase = “connect”,

},

The operation of the blackhole would be to modify the reception processing mail flow so that any newly received mail destined for the same queue will be marked as permanently failed due to a blackhole (and thus never make an attempt to deliver it), and also will apply the same logic to all of the messages currently in that queue. The blackhole will be temporary and last for a period of 4 hours.

This is much more efficient than trying to send the mail again later; presumably, one of the reasons that the sender was blocked was based on properties of their messages that a large volume of recipients disliked, and there is a high likelihood that the mail that becomes backed up by such a mail block will be more copies of the same content; sending it once the block is lifted is likely to cause the sender to be blocked again. So, purging the queue not only saves resources until the situation is resolved with the recipient, but also minimizes the risk of sending the offending content to more users once it has been resolved.

Another problem scenario is that to do with the rate at which messages are being sent, rather than there being problems with the content of those messages. There are a couple of different ways that receivers track the reception rate of messages, and these are influenced by the way that the SMTP protocol operates.

The first obvious metric is the total number of messages received from a particular source IP address. The next metric is the number of messages received on a given SMTP session (here, session refers to a discrete connection to established from the sender to the receiver). And the next metric is the number of recipients that comprise a batch in SMTP.

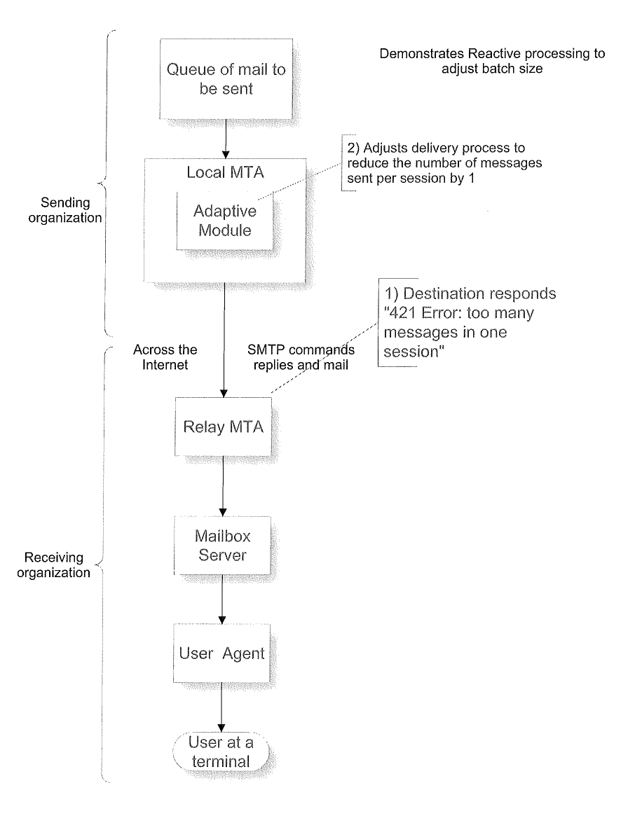

If a sender tries to send “too many” messages in a given session, as illustrated in FIG. 11, the receiver may have a policy that sends back a response like the following:

421 Error: too many messages in one session

The prior art in MTA technology will treat this as a regular transient failure and will continue to butt up against that policy. This can have long term harmful effects on the reputation of the sender, as the receiver may have policies in place that cause that sender to be placed on an internal block list if the behavior persists. There is also the increased cost to the sender of having to retry the messages again later.

Applicant's invention reduces the impact of this by the use of a rule (and additional similar rules can be defined by the local administrator) that looks like this:

{

code = “\hat{ }421 Error: too many messages in one session”,
trigger = “1”,
action = {“reduce_deliveries”, 1},
phase = “mailfrom”,

},

The “code” line matches the SMTP response cited above. The “phase” line scopes this particular rule to the phase of the SMTP dialog where a new batch of mail is being initiated via the “MAIL FROM” command. The “action” line instructs the adaptive delivery module to reduce the maximum number of deliveries per session by 1, so that the next time that messages are delivered to that recipient, the sending system will initiate fewer batches before closing the session. If there is still mail queued after closing the session, the sending system will initiate a new connection/session (this sentence is prior art).

As illustrated in FIG. 12, If a sender tries to send “too many” messages over the course of some receiver policy specific time period, the receiver may decide to issue an SMTP response that looks like the following:

452 Too many recipients received this hour

The prior art in MTA technology will treat this as a regular transient failure and will continue to butt up against that policy with the same implications and effects as described above.

Applicant's invention reduces the impact of this by the use of a rule (and additional similar rules can be defined by the local administrator) that looks like this:

{

code = “\hat{ }452 .*Too many recipients received this hour”,
trigger = “1”,
action = {“throttle”, “down”},
phase = “connect”,

},

The “code” line matches the SMTP response cited above. The “phase” line scopes this particular rule so that it is only evaluated during connection establishment. The “action” line specifies that the sending system should adjust its message-sending throttle downwards. In Applicant's present implementation, each invocation of the “throttle down” action causes a 10% reduction in the throttle setting. Since the response contains no indication of the preferred reception rate, it may take a few occurrences of this response to cause the throttle to fall to a level that is acceptable to the receiver.

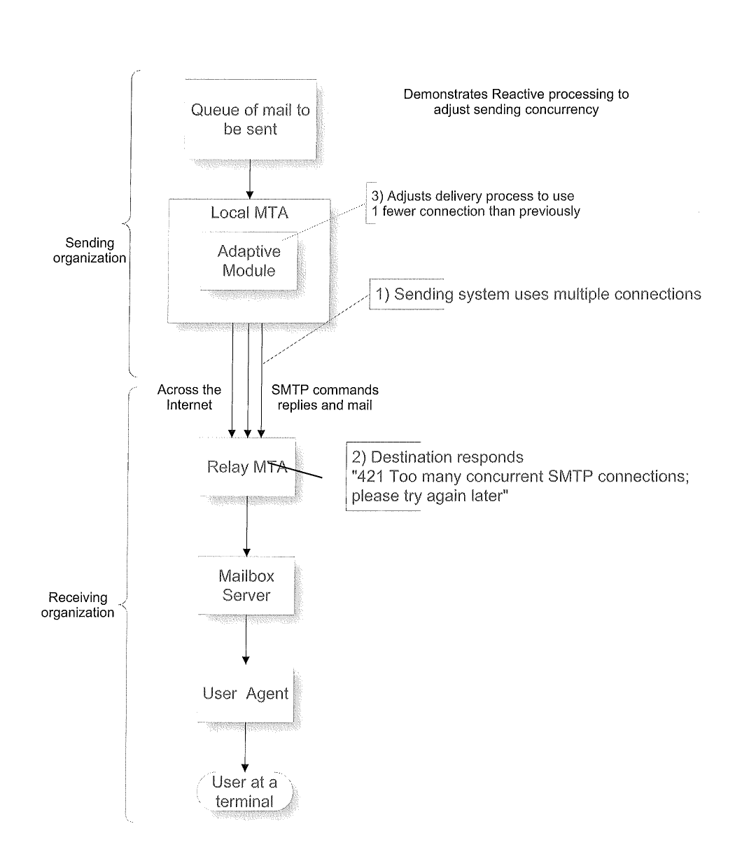

Another traffic shaping metric that is used by receivers is the number of connections established to the receiver from the sender, as illustrated in FIG. 13. The rationale is that a high number of connections may indicate abusive behavior. If a sender exceeds this limit (and the limit is something that is entirely covered by the receiver policies, and may even be dependent upon the connecting IP address), then they may encounter a response along the lines of the following:

421 too many concurrent SMTP connections; please try again later

The prior art in MTA technology will treat this in the same way as regular transient failures as described above, with all the same ramifications.

Applicant's invention deals with this with the use of rules similar to the below (which can also be defined by the local administrator):

{

code = “\hat{ }421 Too many concurrent SMTP connections; please
try again later”,
trigger = “1”,
action = {“reduce_connections”, 1},
phase = “connect”,

},

The important part of this rule is the “action” line, which reduces the number of allowed concurrent connections to the receiver by 1. As with the other similar rules above, it may take a number of occurrences of this response to tune the effective value to be within tolerable limits of the specific receiver.

Another scenario is that a receiver may decide, based on unusual sending behavior, establish a dynamic block and issue a permanent failure response to all messages originating from your address for a certain fixed time period. An example response might be as follows, although this particular item has identifying information replaced with a generic example URL:

554 RLY:B1 dynamic block http://example.com/rlyb1.html

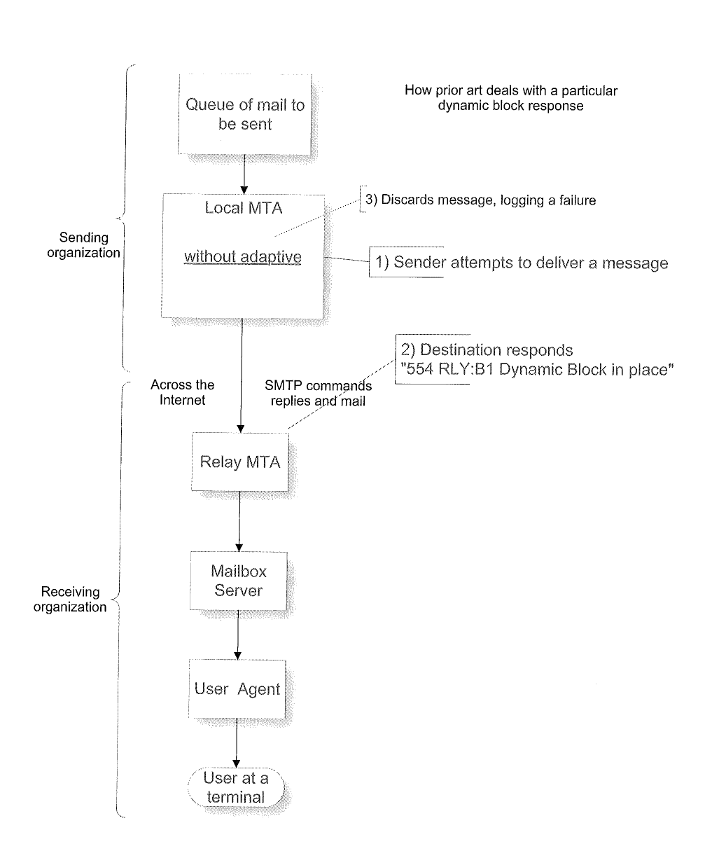

As shown in FIG. 14, the impact that this has on prior-art MTAs is that they will fail all messages that they attempt to send to that destination while the block is in effect. In reality, this particular classification is transient (the actual URL in the real-life response details that the block will expire after 24 hours), which means the subsequently injected (with respect to the block being established) messages will be failed out-of-hand, even though they may be radically different from the content of the messages that triggered the block.

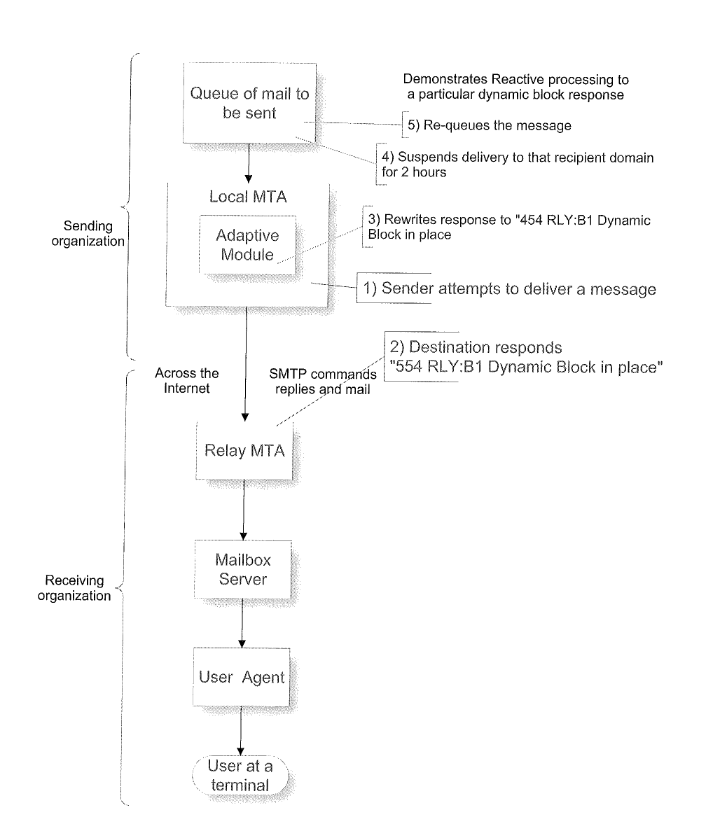

Applicant's invention, as illustrated in FIG. 15, allows the response to be transcoded from a permanent to a transient failure (or vice-versa) using a rule like the following (and as usual, additional rules may be defined by the local administrator):

{

code = “554 RLY:B1”,
trigger = “1”,
action = {“transcode”, “454”, “suspend”, “2 hours”},
message = “Dynamic block in place”,
phase = “connect”,

},

In this case, the “action” specifies that two actions be carried out: 1) rewrite the response code from 554 to 454, converting it from a permanent to a transient response, causing the message that encountered the error to be retried later. 2) enact a suspension lasting 2 hours.

This has the effect of requeuing the messages in a reasonably efficient manner; rather than retrying per the usual retry schedule, the messages will remain in the queue for the next 2 hours; once the suspension is lifted, the messages will be attempted again. If they encounter the same response, they will be transiently failed and a suspension triggered again.

Some receivers maintain data on the historical sending rate of particular sending IP addresses. Their policies place limits on the allowed reception rate of the IP based on the establishment of a good reputation over time. If they have never seen a particular IP address before, they will use fairly restrictive settings on the allowed reception rate, and issue transient failures if these rates are exceeded. As the receiver becomes more familiar with the sender, based on the overall message volume and length of time that the system has been sending, they will increase the permitted reception rate. This concept is known as “IP Warmup” in the industry.

The prior-art MTAs have no mechanism to adapt to this type of time based rate control, requiring explicit configuration changes to adapt. Applicant's invention improves on this in two ways.

The first of these is being able to configure a parametric rate for the receivers that are known to have these policies. An example parametric throttle rate is shown below:

outbound_throttle_messages = function(last, curr, age, mc)

-- 100/hr for 4 days,
-- raise to 1000/hr for next 5 days
age = age / 86400; -- convert to age in days
if age <= 4 then

return 100;

end
if age <= 10 then

return 1000;
end
return 0;

end,

This is expressed as a function in the “Lua” language. The parameters to the function are:

Curr—the current value for the outbound message throttle rate, which may include a speculative adjustment

Last—the value for outbound message throttle rate that was used up until this point

Age—the locally recorded age of the IP address

Mc—the locally recorded message volume sent from this IP address to the receiver in question

As the comment in the function indicates, this particular setting causes the throttle rate to be set to 100 messages per hour for the first 4 days that the IP address is used, upscaling to 1000 messages per hour for the next 5 days, and then removes the throttle after that time period.

The age of the IP address is assumed to be 0 when the system is first provisioned, but this can be explicitly set by the local administrator. Similarly for the “mc” parameter (the message volume), although in Applicant's current embodiment, Applicant doesn't track the message volume and have no rules that use it.

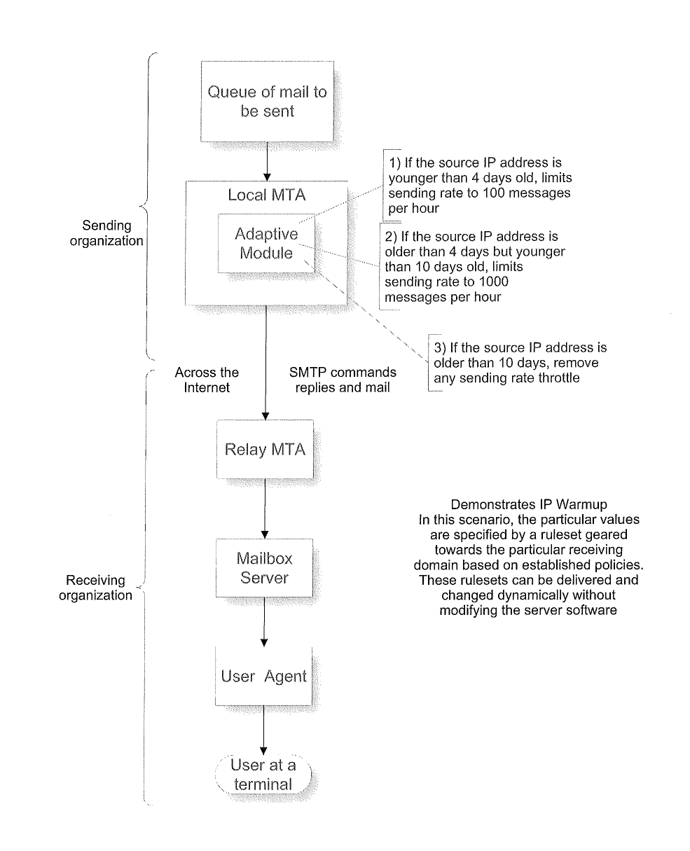

The other facet of Applicant's invention that improves on the prior art in the face of “IP Warmup” receiving policies is the ability to dynamically react to responses that indicate that Applicant should do so, as shown in FIG. 16. For instance, if a given IP address with an established reputation reduces its sending rate to zero for an extended period of time, a receiver may decide to reset it so that it has an infant status.

If the sender were then to ramp up their sending to the levels that were possible with the prior reputation, they may run into a response like this:

412 RP-001 the mail server IP has exceeded the rate limit

This response can also arrive if the complaint volume for the sending raises too high and triggers an automated temporary block.

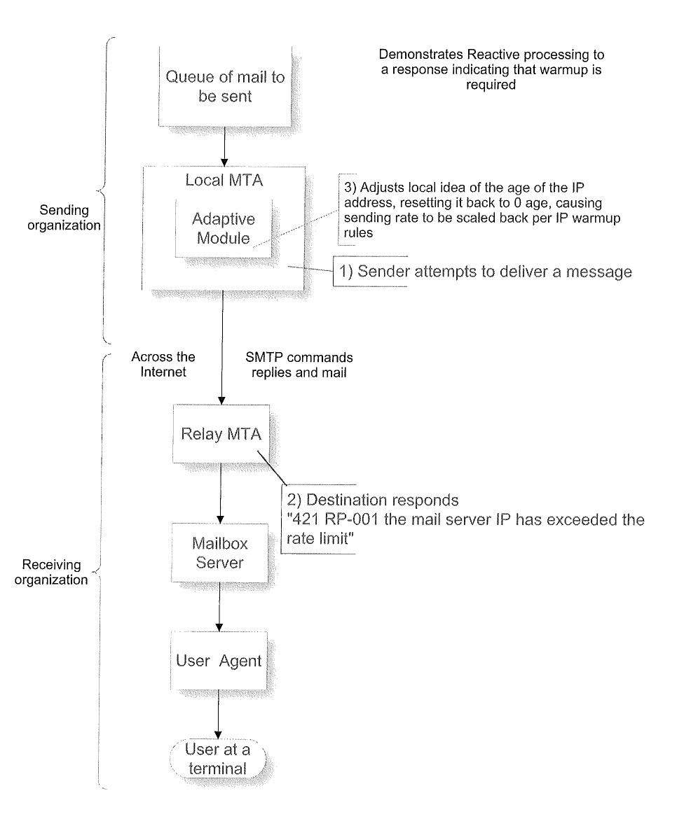

In both cases, the recommended practice is to re-warm the sending IP address, as illustrated in FIG. 17. The prior-art MTAs have no capability to do this, effectively suspending their outbound mail flow to that particular destination, but through the use of rules like the following (which can also be set by the local administrator), Applicant's invention allows mail to flow once again, albeit at a lower, more acceptable rate:

{

code = “421 RP-00[123]”,
trigger = “1”,
action = {“warmup”, “1”},
phase = “connect”,

},

The “warmup” action causes the recorded age of the IP address in question to be reset, starting causing the parametric throttle rate to select a lower value.

### Periodic Parameter Adjustment

A lot of the techniques above are used to adjust the traffic shaping parameters downwards in response to events that indicate that the rates should be reduced.

While this is an effective means to automatically reduce rates, there also needs to be a mechanism that works in the opposite direction to increase rates if it seems like it would help.

The prior art in this area is not automated; the local administrator must manually adjust the shaping parameters to suit the changing needs of their system.

The adaptive delivery invention employs a simple heuristic in its current embodiment; when evaluating the value of a traffic shaping parameter (such as the number of concurrent connections, or the rate at which messages should be sent), if the system has not made a negative adjustment within a configurable time period (default 1 hour), then the system will speculatively increase the value of the parameter by 1.

This allows the system to gradually open up the sending rate, without manual intervention, after it has been calmed by one of the techniques described in the preceding pages.

### Periodic Aggregate Disposition Checks

The majority of the functionality described in the preceding pages talks about reactions to specific responses encountered by the system when attempting to deliver to a recipient. The protocol indicates that these responses are primarily geared towards information the sender of the status of the reception of a given message payload, although it is possible that the recipient will send back more of a blanket response during the connection phase if they have opted to establish a mail block.

Having a system based purely on individual message disposition results is not sufficient for managing a good sending reputation (and thus having an optimal sending rate); if the messages are being rejected at a higher than usual (or otherwise acceptable) rate by the receiver, it is indicative of a problem that can require intervention to preserve the sender reputation. For instance, perhaps a typo was made in some message content causing it to be offensive, or perhaps an overly aggressive marketing campaign looks more like spam mail than it should, or in the case of Email Service Providers (organizations that provide outsourced email sending capabilities for others), a customer violates terms of service and deliberately sends spam mail.

In these cases, the complaint or rejection rate will be unusually high and indicates that a mail block is likely to be enacted if the behavior continues. The prior-art message relaying technology does not have any automated mechanisms to manage this. Most sending institutions have set up business level monitors that alert an operator to take manual action. Applicant's invention improves on this situation by automatically taking actions and sending alerts.

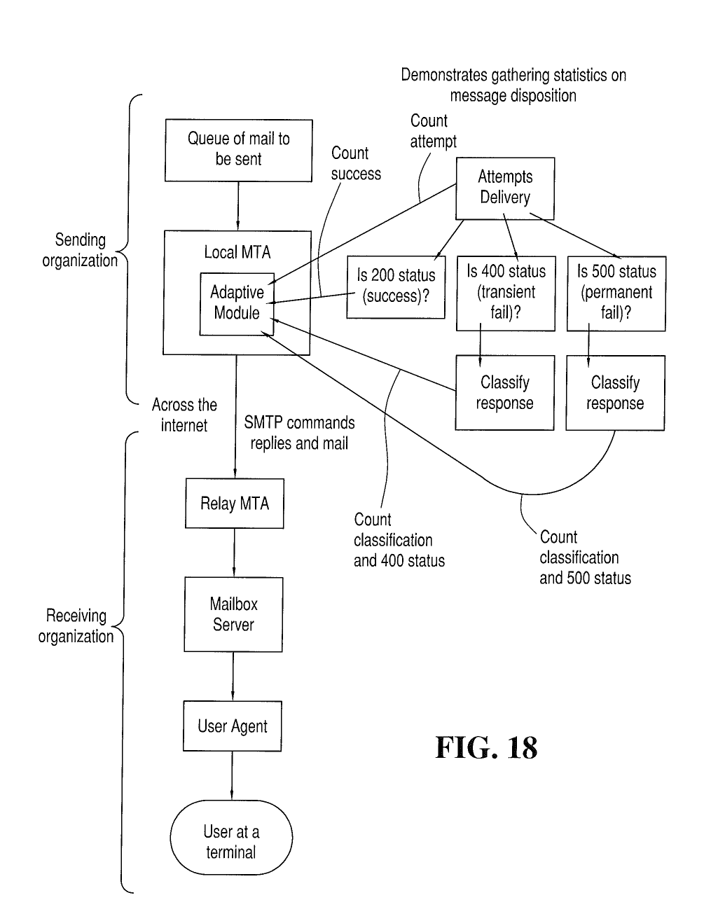

As shown in FIG. 18, Applicant's solution records the volumes of messages that were attempted, succeeded and failed for each source IP to each recipient domain.

Applicant also recognize that the reason why a receiver rejects a given message can be fairly nuanced. Applicant's solution, like some others (so this paragraph is effectively prior art and not a claim) classifies SMTP responses and out-of-band bounce reports into one of a number of reasons.

As an illustrative example, Applicant's list of bounce classification codes is reproduced in the Table below:

| Code | Type | Description |
|---|---|---|
| 1 | Undetermined | The response text could not be identified |
| 10 | Invalid Recipient | The recipient is invalid |
| 20 | Soft Bounce | The message soft bounced |
| 21 | DNS Failure | The message bounced due to a DNS failure |
| 22 | Mailbox Full | The message bounced due to the remote |
| | | mailbox being over quota |
| 23 | Too Large | The message bounced because it was too |
| | | large for the recipient |
| 24 | Timeout | The message timed out |
| 25 | Admin Failure | The message was failed by local configured |
| | | policies |
| 30 | Generic Bounce: | No recipient could be determined for the |
| | No RCPT | message |
| 40 | Generic Bounce | The message failed for unspecified reasons |
| 50 | Mail Block | The message was blocked by the receiver |
| 51 | Spam Block | The message was blocked by the receiver |
| | | as coming from a known spam source |
| 52 | Spam Content | The message was blocked by the |
| | | receiver as spam |
| 53 | Prohibited | The message was blocked by the receiver |
| | Attachment | because it contained an attachment |
| 54 | Relaying Denied | The receiver will not relay for that domain |
| 60 | Auto-Reply | The message is an auto-reply/vacation mail |
| 70 | Transient Failure | Message transmission has been temporarily |
| | | delayed |
| 80 | Subscribe | The message is a subscribe request |
| 90 | Unsubscribe | The message is an unsubscribe request |
| 1100 | Challenge- | The message is a challenge-response probe |
| | Response | |

Broadly speaking, “bounce classification” is not suitable to solve the problems solved by the system and method of the present invention, instead, applicants' system records the volume of each of the bounce classifications over time and may then act in response to this as part of periodic aggregate disposition checks.

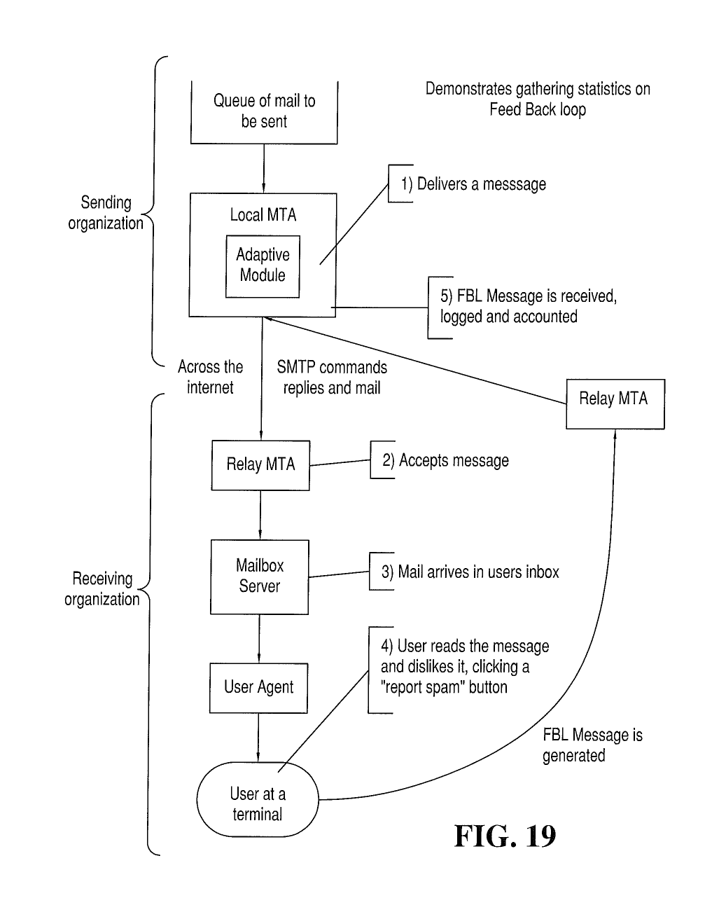

In addition, Applicant's software also records the volumes of Feed-Back Loop (FBL) complaints that are sent back to the system from the major receivers, as illustrated in FIG. 19. The FBL is a standard mechanism for relaying information about user complaints from the major ISPs. These are implemented via a “report spam” or similar button in the end-user email software. When a user complains, the ISP records this, and if the sender has arranged to be a part of the FBL with that receiver, a special FBL report email is sent back to the sender. The concept with the FBL is that the sender will take steps to remedy the complaint in short order, with the typical resolution being that the recipient should be unsubscribed or otherwise taking steps to avoid sending content to that recipient again.

FBL complaints are sensitive, with the major ISPs likely to enact a block against a sender if the complaint rate rises to something in the range of 0.5% to 1% of the volume of messages from that sender.

FBL complaints can be categorized into one of the following:

abuse

fraud

invalid dkim signature

virus

other

So, in accordance with the present invention, a periodic aggregate disposition is evaluated.

For a simple example, say an administrator wants to suspend deliveries if 10% or more of message traffic is being rejected by a given recipient. However, the threshold needs to be statistically significant; if a sender sends one message and it is rejected immediately, the rejection rate is effectively 100% at that point. So, in accordance with the present invention, a parameter is provided that allows the administrator to specify the minimum amount of messages that need to have been attempted before this processing can take effect. An example default for this threshold parameter is 100 messages.

The system of the present invention processes the periodic aggregate disposition checks every hour (configurable) and provides a number of different rules (that can be configured by the local administrator) to control the behavior.

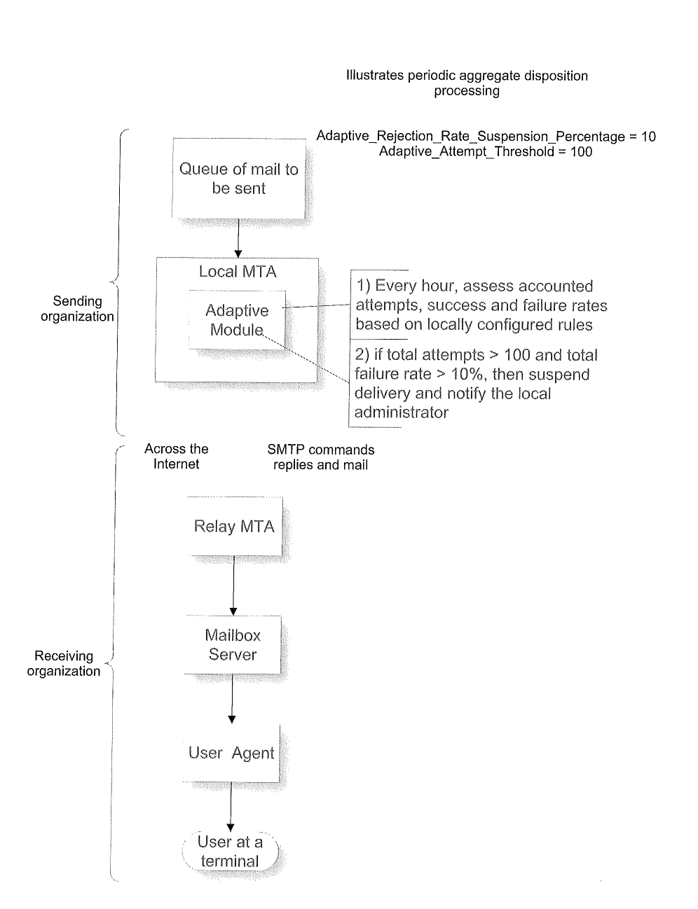

For example, as shown in FIG. 20, the illustrated configuration causes a suspension to be enacted when the total rejection rate, based on the protocol level responses, reaches 10%, but only if at least 100 messages have been attempted:

Adaptive_Rejection_Rate_Suspension_Percentage = 10
Adaptive_Attempt_Threshold = 100

For more granularity, rules such as the following can be specified:

Codes = ( “bc:10” “bc:23” “bc:22” ) # correspond to
bounce codes table above
Low_Threshold = 3
Low_Action =( “throttle” “down” )
High_Threshold = 10
High_Action = ( “suspend” “4 hours” )

This rule states that if the total volume of rejections classified as an invalid recipient, mailbox full or message too large reaches 10%, then the message flow to that recipient domain will be suspended. Otherwise, if the rate reaches 3% then the system will reduce the sending rate by 10% (per the description of throttle down earlier in this document).

The actions that can be specified here are the same as those described in the earlier part of this document.

The list of codes can be chosen by local administrator and the rules can themselves be specified on a per recipient domain per sending IP basis.

An example of using the FBL data:

Codes = ( “fbl:abuse” )
Low_Threshold = 0.3
Low_Action = ( “throttle down” )
High_Threshold = 0.5
High_Action = (“suspend” “4 hours”)

This rule has the effect of reducing the sending rate once the FBL abuse complaint rate reaches or exceeds 0.3%, and suspending the sending if it reaches 0.5%.

Since these rules are assessed every hour (configurable), the Low_Threshold may trigger multiple times, having a stronger calming effect over time.

Applicant's invention records the bounce classification and overall volume statistics windowed to a 1 hour interval (configurable), which has the effect of automatically causing the statistics to fall below the triggering threshold over time. Applicant's invention records the FBL data over a longer time period of 24 hours (configurable) since the low trigger threshold and established practices of the receivers require this in order for the solution to be effective.

### SUMMARY

Persons of skill in the art will appreciate that the present invention as described herein and illustrated in FIGS. 3-20 makes the following automated message delivery method and system benefits and features available:

(1) A method for controlling delivery of digital messages such as E-mails transmitted via networks of computer systems, comprising the method steps of:
(a) submitting a message for transmission to at least one identified recipient 170;
(b) queue-ing the message with a selected immediate attempt time by storing said message in a selected message queue;
(c) examining said a selected message queue and determining whether said identified recipient has a blackhole in effect, and, if so,
(d) failing all messages queued for the identified recipient domain (e.g., yahoo.com), and
(e) waiting for a response pending an externally or internally triggered action.

Applicant's implementation performs the queue-level purge at the time the blackhole state or status is entered, not during reception of new messages. So when describing the process for reception of new messages, it is noted that a newly arrived message is rejected when a black hole status is in effect. In the figures, where “Wait” is used as a block (e.g., FIG. 3), it indicates that the system is idle pending some other externally or internally triggered action.

(2) A method for controlling delivery of digital messages such as E-mails transmitted via networks of computer systems, comprising the method steps of:
(a) submitting a message for transmission to at least one identified recipient 170;
(b) queue-ing the message by storing said message in a selected message queue with a selected immediate attempt time;
(c) examining queue and determining whether the identified recipient has a blackhole in effect, and, if not,
(d) determining whether the identified recipient has a suspension in effect, and, if so,
(e) waiting for a response pending an externally or internally triggered action.

(3) A method for controlling delivery of digital messages such as E-mails transmitted via networks of computer systems, comprising the method steps of:
(a) submitting a message for transmission to at least one identified recipient 170;
(b) queue-ing the message by storing said message in a selected message queue with a selected immediate attempt time;
(c) examining queue and determining whether the identified recipient has a blackhole in effect, and, if not,
(d) determining whether the identified recipient has a suspension in effect, and, if not,
(e) determining whether the message is due for delivery at the then-extant time and, if not,
(f) waiting for a response pending an externally or internally triggered action.

(4) A method for controlling delivery of digital messages such as E-mails transmitted via networks of computer systems, comprising the method steps of:
(a) providing a message disposition rule set for use when evaluating message transmission to at least one identified recipient 170;
(b) attempting transmission of a subject message to at least one identified recipient and
(c) receiving or logging message disposition information generated in response to the subject message's attempted transmission;
(c) evaluating the message disposition rule set for the identified recipient against the message disposition information for previously attempted transmissions to the identified recipient;
(d) determining whether a rule from said message disposition rule set matches or is triggered by the message disposition information, and
(e) applying selected adaptive actions specified by the matching rule; wherein said adaptive actions may include setting a blackhole status, setting a suspension status, adjusting shaping parameters, throttling down sending rate to a selected limit, reclassifying disposition from permanent to transient or reclassifying disposition from transient to permanent.

(5) A digital message system programmed and configured to execute a method for processing a plurality of digital messages that are being sent to recipients (e.g., 170) at a plurality of destination domains, the method comprising:
(a) establishing a plurality of message disposition Rulesets in the system, wherein each Ruleset in the plurality of Rulesets is for handling digital messages to a specific domain or set of domains in the plurality of destination domains;
(b) receiving at the system a request to process for transfer a plurality of outbound digital messages, each digital message specifying delivery to at least one recipient at a particular domain or set of domains;
(c) for each given digital message, processing the given digital message by: determining a destination domain for the given digital message; reading a Ruleset, in the plurality of Rulesets, for the determined destination domain of the given digital message or for a set of destination domains that includes the determined destination domain of the given digital message; and, based on at least one Rule in the Ruleset, either:
   (i) sending the given digital message to the determined destination domain in accordance with the Ruleset when permitted by the at least one Rule in the Ruleset or
   (ii) holding the given digital message without sending the digital message to the determined destination domain when required by the at least one Rule in the Ruleset; and
(d) for the given digital message, once sent, determining the message disposition;
(e) evaluating the Ruleset and the message disposition;
(f) determining whether a Rule from the Ruleset matches the disposition, and, if so,
(g) applying actions specified by the matching rule to revise and adapt the Ruleset in response to said message disposition, and generating a newly adapted Ruleset; For example, the applied action can be storing the revised shaping parameters in a data store, to provide an adapted rule set.

(6) The digital message system of claim 5, wherein the revision in method step (g) alters one or more Rules in at least one of the Rulesets thereby affecting how the digital message system sends e-mail to the domain or the set of domains associated with each of the one or more Rulesets.

(7) A method for controlling delivery of digital messages such as e-mails transmitted via networks of computer systems, comprising:
(a) submitting a first message from a first user for transmission to at least one identified first recipient 170;
(b) Enqueuing said first message by storing said message in a selected message queue with an immediate attempt time in a first queue;
(c) examining said first queue and determining whether said first message has the status of a Blackhole, and, if not,
(d) determining whether said first message has the status of a suspension in effect, and if not,
(e) determining if said first message is due for delivery now, and, if so,
(f) removing said first message from said first queue and attempt delivery,
(g) determining if delivery of said first message was successful, and if not,
(h) determining whether delivery of said first message is a permanent failure, and if so,
(i) processing failed delivery of said first message.

(8) The method of claim 7, wherein said first message has the status of a Blackhole and the examining step (c) further comprises:
(i) failing all messages queued for said first recipient; and
(ii) waiting for a response pending an externally or internally triggered action.

(9) The method of claim 7, wherein said first message has the status of a suspension in effect and the determining step (d) further comprises:
(i) waiting for a response pending an externally or internally triggered action.

(10) The method of claim 7, wherein said first message is not due for delivery instantly and determining step (e) further comprises:
(i) waiting for a response pending an externally or internally triggered action.

(11) The method of claim 7, wherein delivery of said first message is successful and determining step (g) further comprises:
(i) processing successful delivery of said first message.

(12) The method of claim 7, wherein delivery of said first message is not a permanent failure and determining step (h) further comprises;
(i) Requeuing said first message in said first queue with a later attempt time.

(13) A method for controlling delivery of digital messages such as e-mails transmitted via networks of computer systems, comprising:
(a) determining if said first message from a first user for transmission to at least one identified first recipient 170 is eligible for delivery;
(b) determining if a connection can be re-used, and, if so,
(c) re-using the connection;
(d) determining if the message send rate has been exceeded, and if not,
(e) delivering said first message to said first recipient.

(14) The method of claim 13, wherein said connection cannot be re-used and determining step (b) further comprises:
(i) determining if permitted to open a new connection, and if so,
(ii) attempting a new connection;
(iii) determining if the connection has been established, and if so,
(iv) using the connection;
(v) determining if the message send rate has been exceeded, and if not,
(vi) delivering said first message to said first recipient.

(15) The method of claim 14, wherein said message send rate has been exceeded and determining step (e) further comprises:
(i) waiting.

(16) The method of claim 14, wherein said connection is not established and determining step (c) further comprises:
(i) indicating transient failure.

(17) The method of claim 14, wherein said new connection is not permitted and determining step (b) further comprises:
(i) indicating transient failure.

(18) A method for controlling delivery of digital messages such as e-mails transmitted via networks of computer systems, comprising:
(a) processing a first message from a first user for transmission to an identified first recipient 170;
(b) receiving a first message attempt disposition and evaluating a first Ruleset against said first message attempt disposition;
(c) determining whether said first message attempt disposition matches a rule in said Ruleset, and if not,
(d) determining whether a first DSN should be sent, and if not,
(e) logging the first message attempt disposition.

(19) The method of claim 18, further comprising:
(f) processing a second message from a first user for transmission to an identified first recipient 170;
(g) receiving a second message attempt disposition and evaluating the first Ruleset against said second message attempt disposition;
(h) determining whether said second message attempt disposition matches or triggers a rule in said Ruleset, and if so,
(i) applying a responsive action specified in the said triggered rule.

(20) The method of claim 19, wherein said responsive action is selected from including the following options:
setting a blackhole status,
setting a suspension status,
adjusting shaping parameters,
reclassifying disposition from permanent to transient, or
reclassifying disposition from transient to permanent.

(21) A system for controlling delivery of digital messages such as e-mails transmitted via networks of computer systems, comprising:
(a) a sender/user terminal;
(b) a sender mail user agent or message injector;
(c) a queue of mail to be sent;
(d) a programmable adaptive module;
(e) a client message transfer agent;
(f) a server message transfer agent;
(g) a receiver mail user agent;
(h) a receiver terminal;

(22) A system 200 for controlling delivery of digital messages such as e-mails transmitted via networks of computer systems, comprising:
(a) a queue of mail to be sent;
(b) a local mail transfer agent with an adaptive module;
(c) at least one relay message transfer agent;
(d) a mailbox server;
(e) a receiving mail user agent;
(f) a receiving user at a terminal;

(23) A method for controlling delivery of digital messages such as e-mails transmitted via networks of computer systems and reactive processing in the face of greylisting, comprising:
(a) Providing an adaptive module 220 programmed to enqueue and store a first message in a selected message queue
(b) attempting to send said first message from said message queue to a first destination;
(c) receiving a Greylisted message disposition from said first destination,
(d) in response to said Greylisted message disposition, automatically adjusting a retry schedule of said adaptive module so that the message will be retried in a selected retry interval (e.g., 15 minutes).

(24) A method for controlling delivery of digital messages such as e-mails transmitted via networks of computer systems and reactive processing for a mail block, comprising:
(a) receiving a response from the first destination indicating the user IP has been temporarily deferred due to received user complaints,
(b) suspending delivery for the first destination for a specified period of time by said adaptive module,
(c) notifying the local administrator of said adaptive module of suspension status.

(25) A method for controlling delivery of digital messages such as e-mails transmitted via networks of computer systems and reactive processing for a permanent mail block, compromising:
(a) receiving a response from the first destination indicating the user IP has been permanently deferred due to receiving user complaints,
(b) purging contents of the mail queue for the first destination by said adaptive module,
(c) arranging for newly received mail for the first destination to be discarded without delivery attempt for a selected interval (e.g., four hours),
(d) notifying the local administrator of said adaptive module of blocked status.

(26) A method for controlling delivery of digital messages such as e-mails transmitted via networks of computer systems and reactive processing for to adjust batch size, compromising:
(a) receiving a response from the first destination indicating too many messages in a first session,
(b) adjusting the delivery process of the adaptive module to reduce the number of messages sent per session by one.

(27) A method for controlling delivery of digital messages such as e-mails transmitted via networks of computer systems and reactive processing to adjust sending rate, compromising:
(a) receiving a response from the first destination indicating too many messages over the course of a receiver specified period of time,
(b) adjusting the delivery process of the adaptive module to send ten percent slower.

(28) A method for controlling delivery of digital messages such as e-mails transmitted via networks of computer systems and reactive processing to adjust sending concurrency, compromising:
(a) using multiple connections by sending local message transfer agent,
(b) receiving a response from the first destination indicating too many concurrent SMTP connections,
(c) adjusting the delivery process of the adaptive module to use one fewer connections.

(29) A method for controlling delivery of digital messages such as e-mails transmitted via networks of computer systems and reactive processing to a particular dynamic block, compromising:
(a) attempting delivery of a message to a first destination,
(b) receiving a response from the first destination indicating a dynamic block in place,
(c) rewriting the response from a permanent to a transient response,
(d) suspending delivery to the first destination for a selected interval (e.g., two hours),
(e) requeuing said first message in said first queue.

(30) A method for controlling delivery of digital messages such as e-mails transmitted via networks of computer systems and reactive processing to a response indicating that warmup is required, compromising:
(a) attempting delivery of said first message to a first destination,
(b) receiving a response from the first destination indicating the local MTA has exceeded the rate limit,
(c) resetting the local idea of the age of the IP address of the adaptive module to zero.

(31) A method for controlling delivery of digital messages such as e-mails transmitted via networks of computer systems and gathering statistics on Feed Back Loop, compromising:
(a) attempting delivery of said first message to a first destination,
(b) accepting said first message by first relay mail transfer agent,
(c) transferring said first message from receiving mailbox server to receiving user's user agent,
(d) delivering said first message to receiving user at terminal,
(e) reporting said first message as spam by the receiving user,
(f) receiving, logging, and accounting Feed Back Loop message by the local message transfer agent with adaptive module.

Having described preferred embodiments of a new and improved method and system 200, it is believed that other modifications, variations and changes will be suggested to those skilled in the art in view of the teachings set forth herein. It is therefore to be understood that all such variations, modifications and changes are believed to fall within the scope of the present invention.

What is claimed is:

1. A method for controlling delivery of digital messages such as E-mails transmitted via networks of computer systems, comprising the method steps of:
(a) submitting a first message for transmission to at least one identified recipient;
(b) queue-ing the first message with a selected immediate attempt time by storing said first message in a selected message queue;
(c) examining said a selected message queue and determining whether said identified recipient has a blackhole in effect, and, if so,
(d) failing all messages queued for the identified recipient, and
(e) waiting for a response pending an externally or internally triggered action.

2. The method for controlling delivery of digital messages such as E-mails transmitted via networks of computer systems of claim 1, further comprising the method steps of:
(f) submitting a second message for transmission to a second identified recipient;
(g) queue-ing the second message by storing said second message in said selected message queue with a selected immediate attempt time;
(h) examining said queue and determining whether the identified second recipient has a blackhole in effect, and, if not,
(i) determining whether the identified recipient has a suspension in effect, and, if so,
(j) waiting for a response pending an externally or internally triggered action.

3. A method for controlling delivery of digital messages such as E-mails transmitted via networks of computer systems, comprising the method steps of:
(a) providing a message disposition rule set for use when evaluating message transmission to at least one identified recipient;
(b) attempting transmission of a subject message to at least one identified recipient and
(c) receiving or logging message disposition information generated in response to the subject message's attempted transmission;
(c) evaluating the message disposition rule set for the identified recipient against the message disposition information for previously attempted transmissions to the identified recipient;
(d) determining whether a rule from said message disposition rule set matches or is triggered by the message disposition information, and
(e) applying selected adaptive actions specified by the matching rule; wherein said adaptive actions may include setting a blackhole status, setting a suspension status, adjusting shaping parameters, throttling down sending rate to a selected limit, reclassifying disposition from permanent to transient or reclassifying disposition from transient to permanent.

4. A digital message system programmed and configured to execute a method for processing a plurality of digital messages that are being sent to recipients at a plurality of destination domains, the method comprising:
(a) establishing a plurality of message disposition Rulesets in the system, wherein each Ruleset in the plurality of Rulesets is for handling digital messages to a specific domain or set of domains in the plurality of destination domains;
(b) receiving at the system a request to process for transfer a plurality of outbound digital messages, each digital message specifying delivery to at least one recipient at a particular domain or set of domains;
(c) for each given digital message, processing the given digital message by: determining a destination domain for the given digital message; reading a Ruleset, in the plurality of Rulesets, for the determined destination domain of the given digital message or for a set of destination domains that includes the determined destination domain of the given digital message; and, based on at least one Rule in the Ruleset, either:
(i) sending the given digital message to the determined destination domain in accordance with the Ruleset when permitted by the at least one Rule in the Ruleset or
(ii) holding the given digital message without sending the digital message to the determined destination domain when required by the at least one Rule in the Ruleset; and
(d) for the given digital message, once sent, determining the message disposition;
(e) evaluating the Ruleset and the message disposition;
(f) determining whether a Rule from the Ruleset matches the disposition, and, if so,
(g) applying actions specified by the matching rule to revise and adapt the Ruleset in response to said message disposition, and generating a newly adapted Ruleset.

5. The digital message system of claim 4, wherein the revision in method step (g) alters one or more Rules in at least one of the Rulesets thereby affecting how the digital message system sends e-mail to the domain or the set of domains associated with each of the one or more Rulesets.

6. The digital message system of claim 4, wherein the system is programmed and configured to modify the Ruleset to execute a method for processing a plurality of digital messages that are being sent to recipients at a plurality of destination domains, the modification method comprising:
(a) submitting a first message from a first user for transmission to at least one identified first recipient;
(b) Enqueuing said first message by storing said message in a selected message queue with an immediate attempt time in a first queue;
(c) examining said first queue and determining whether said first message has the status of a Blackhole, and, if not,
(d) determining whether said first message has the status of a suspension in effect, and if not,
(e) determining if said first message is due for delivery now, and, if so,
(f) removing said first message from said first queue and attempt delivery,
(g) determining if delivery of said first message was successful, and if not,
(h) determining whether delivery of said first message is a permanent failure, and if so,
(i) processing failed delivery of said first message.

7. The digital message system of claim 6, wherein the system is programmed and configured to modify the Ruleset to execute a method for processing a plurality of digital messages that are being sent to recipients at a plurality of destination domains, the modification method examining step (c) further comprises:
(i) failing all messages queued for said first recipient; and
(ii) waiting for a response pending an externally or internally triggered action.

8. The digital message system of claim 4, further comprising:
(a) a sender/user terminal;
(b) a sender mail user agent or message injector;
(c) a queue of mail to be sent;
(d) a programmable adaptive module;
(e) a client message transfer agent;
(f) a server message transfer agent;
(g) a receiver mail user agent;
(h) a receiver terminal;

9. The digital message system of claim 4, further comprising:
(a) a queue of mail to be sent;
(b) a local mail transfer agent with an adaptive module;
(c) at least one relay message transfer agent;
(d) a mailbox server;
(e) a receiving mail user agent;
(f) a receiving user at a terminal;
